(19) United States
(12) Patent Application Publication
(10) Pub. No.: US 2025/0379840 A1
(43) Pub. Date: Dec. 11, 2025

(54) Systems and Methods for Managing Messaging Communications

(71) Applicant: Daniel LEVI, Tel-Aviv (IL)

(72) Inventor: Daniel LEVI, Tel-Aviv (IL)

(21) Appl. No.: 19/309,964

(22) Filed: Aug. 26, 2025

Related U.S. Application Data
(63) Continuation-in-part of application No. 19/273,004, filed on Jul. 17, 2025.

(30) Foreign Application Priority Data
Jun. 10, 2025 (IT) 102025000013534

(51) Int. Cl. H04L 51/212; G06F 40/205; G06F 40/284; G06F 40/35; G10L 15/16; G10L 25/63; G10L 25/90; H04L 51/046; H04L 51/066; H04L 51/10

(52) U.S. Cl. CPC H04L 51/212; G06F 40/205; G06F 40/284; G06F 40/35; G10L 25/63; G10L 25/90; H04L 51/046; H04L 51/066; H04L 51/10; G10L 15/16

(57) ABSTRACT

A method and system for managing digital messaging communication on a user device, comprising a neural network-based speech recognition model and a decision-making algorithm. The system performs local analysis to identify and flag harmful or unauthorized content, incorporating real-time acoustic feature extraction and contextual data to refine content evaluation and transmission decisions.

### CROSS REFERENCE TO RELATED APPLICATIONS

This application is a Continuation-in-Part of U.S. patent application Ser. No. 19/273,004, filed Jul. 17, 2025, which claims the benefit of priority of Italian Patent Application No. 102025000013534, filed Jun. 10, 2025, the contents of which are all incorporated herein by reference in their entirety.

### FIELD OF THE INVENTION

The present disclosure pertains to communication systems for mobile and web-based platforms. Specifically, it addresses a digital communication module utilizing artificial intelligence for real-time moderation and analysis.

### BACKGROUND

In the field of mobile and web-based communication systems, traditional methods such as voice calls and recorded messages present several limitations. These conventional systems often lack user control, real-time moderation, and intelligent interaction capabilities. As a result, platforms that facilitate service delivery, online interactions, or customer support frequently encounter challenges related to harassment, inefficiency, and communication overload. The absence of a structured, consent-based digital message interaction system that incorporates real-time AI moderation further exacerbates these issues.

Existing digital communication solutions, such as email or instant messaging, typically require persistent user control or account linkage, which are not suitable for ad hoc, one-time, anonymized coordination. These models are inadequate for scenarios where communication should be limited in time, linked to a specific task or transaction, and anonymous by design. Furthermore, they often lack automated activation and deactivation features, which are crucial for maintaining privacy and reducing unnecessary exposure.

The current state of communication technology does not adequately address the need for temporary, session-based digital communication that is both context-aware and privacy-preserving. Traditional systems often require manual intervention to initiate or terminate communication, leading to inefficiencies and potential privacy breaches. Additionally, these systems do not provide the flexibility needed for cross-platform support, which is essential for users who may not have prior app installations.

What is needed is a communication system that enables structured, consent-based digital message interactions with real-time AI moderation. Such a system would allow users to initiate message requests in a non-intrusive manner, with the recipient having the option to accept or ignore the interaction. The integration of AI modules for real-time sentiment analysis and behavioral moderation would enhance security and efficiency, while preserving user privacy by eliminating the need for personal information sharing. This approach would address the shortcomings of existing technologies by providing a flexible, context-aware solution that is applicable across various platforms and industries.

### SUMMARY

In one aspect, the technology pertains to a method for managing digital communication on a user device. This method involves performing a local analysis of digital messages prior to their transmission to a recipient, thereby determining whether to transmit or block the message in real-time. The local analysis may include identifying harmful, offensive, or policy-violating content, ensuring that communication adheres to predefined standards.

One object of the technology is to enhance user control and privacy in digital communication by enabling real-time moderation directly on the user device. This approach reduces reliance on server-side processing, thereby preserving user privacy and complying with data protection regulations. The system aims to improve communication efficiency and safety by preventing the transmission of inappropriate content.

In an embodiment, the content recognition model utilized in the method is a neural network-based model, which may enhance the accuracy of content analysis. The local analysis module may further incorporate a real-time feature extraction component, evaluating various attributes such as tone, pitch, and volume in audio, or visual elements in images and videos, to refine the decision-making process regarding the transmission of digital messages.

In another aspect, the system for managing digital communication comprises a user device equipped with a processor and memory, configured to transmit digital messages. The system includes a decision-making algorithm that may be dynamically updated and is capable of real-time detection of bullying, threats, or harassment. This system facilitates user-device-level policy enforcement for regulatory compliance.

Yet another object of the technology is to provide a mechanism for user interaction that is both secure and efficient, allowing users to engage in communication without exposing personal information. The system supports a consent-based interaction model, where flagged messages are presented to the user with options to confirm or cancel transmission, thereby enhancing user autonomy and trust in the communication process.

### BRIEF DESCRIPTION OF THE DRAWINGS

FIG. 1 is a block diagram of a voice communications system comprising a user interface, communication module, receiver module, voice streaming module, and AI filtering module.

FIG. 2 is a flowchart illustrating a method for facilitating voice communication between users, comprising steps for initiating, transmitting, and moderating audio data.

FIG. 3 is a flowchart illustrating a method for moderating digital messages, comprising steps for capturing, analyzing, approving or rejecting, and transmitting messages based on compliance with predefined standards.

FIG. 4 is a flowchart illustrating the process for managing digital audio communication, including steps for receiving audio input, validating the input, processing the audio, providing feedback, and adjusting settings based on user feedback.

### DETAILED DESCRIPTION OF THE INVENTION

In one aspect, the present invention relates to a communication system comprising several components that facilitate structured, consent-based digital communication of messages. A digital message can include any combination of text, voice, image and video.

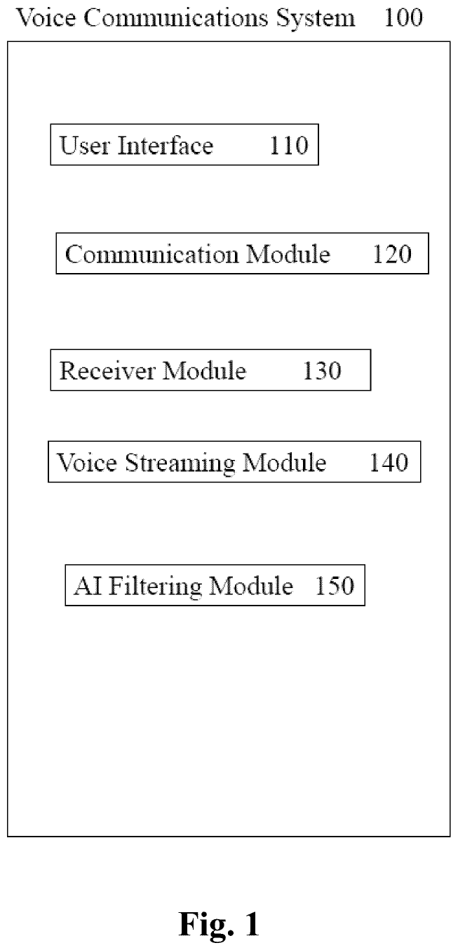

FIG. 1 shows a schematic representation of a voice communications system 100, which comprises several key components designed to facilitate secure and intelligent voice interactions. The system includes a user interface 110, which serves as the primary point of interaction for users, allowing them to initiate and manage digital messages.

The communication module 120 is responsible for managing the transmission of signals between users. This module may activate signal transmission based on various conditions, such as geographic location or predefined event timing, ensuring that communication is contextually relevant and timely.

The receiver module 130 functions to handle incoming communication requests, allowing the recipient to accept or ignore interactions. This module ensures that the communication channel is only opened upon the recipient's consent, thereby preserving user privacy and control.

The voice streaming module 140 facilitates the real-time streaming of audio data between users once the communication channel is established. This module ensures that voice data is transmitted efficiently and securely during the interaction.

The AI filtering module 150 is integrated to analyze audio data in real-time, detecting sentiment and classifying interaction types. It enforces behavioral standards by identifying inappropriate language or behavior, and it may automatically terminate the live audio stream upon detection of predefined violations. This module enhances the security and quality of the communication by providing real-time moderation and filtering capabilities.

In one aspect, the present invention relates to a method for managing digital messages involving a comprehensive process executed locally on a user device (mobile phone, tablet, PC and similar devices) equipped with a processor and memory. This process is designed to handle digital messages in the form of communication signals that may comprise any combination of representations of text, audio, images, and video. The user device is configured to transmit these messages through an interface, ensuring efficient and secure communication.

The process begins with the execution of a local analysis module, which is performed in the user device's memory and executed by the processor. This module is responsible for processing the communication signals. If the signal is not originally in text form, the module attempts to convert it to text, or to extract the text portion, using a recognition model appropriate to the signal type. For instance, audio signals are transcribed into text using a speech recognition model, while images and video may be processed using optical character recognition (OCR) or video analysis techniques to extract textual information. In a video signal, the audio portion can ba analyzed separately, using text-to-speech techniques. This transformation is crucial for enabling subsequent analysis, as it allows the system to extract the meaning embedded within the original digital message.

Once the communication signal is converted to text, the system proceeds to analyze in real-time the text or converted text prior to its transmission to a recipient. This analysis involves several key steps. First, the text data is parsed to identify specific keywords that may indicate the nature or intent of the message. Next, natural language processing (NLP) techniques are applied to determine the sentiment of the communication, assessing whether the emotional tone is positive, negative, or neutral. Additionally, the context of the message is evaluated using a predefined lexicon, which may include domain-specific vocabulary relevant to the communication environment.

The decision-making algorithm plays a pivotal role in the process, utilizing the results of the content analysis to determine whether to transmit or block the communication signals in real-time. This algorithm incorporates a set of predefined rules and criteria, which may include identifying harmful, offensive, policy-violating, misleading, inappropriate, or unauthorized content. The decision-making process is designed to ensure that only compliant and appropriate messages are transmitted to the recipient, thereby maintaining the integrity and quality of digital interactions.

In practical applications, this method can be employed across various communication platforms, including mobile applications, web-based interfaces, and enterprise communication systems. For example, in a customer service application, the system can detect if a user is expressing frustration or dissatisfaction, prompting the system to escalate the interaction to a human agent for resolution. Similarly, in a social communication platform, the system can identify positive sentiment, such as enthusiasm or agreement, and adjust the interaction flow accordingly to maintain engagement.

Overall, the method for managing digital messages provides a robust framework for ensuring secure and compliant transmission of communication signals, leveraging advanced recognition and content analysis techniques to maintain the integrity and quality of digital interactions. This approach contributes to a more secure and respectful communication environment across diverse applications and industries.

The system comprises an artificial intelligence (AI) filtering module configured to classify and moderate message data in real-time. The AI module is integrated into the system architecture to facilitate the analysis of different data streams, such as text, voice or video (analyzing the voice part of the video). This integration allows for the continuous monitoring of, enabling the system to process and evaluate data as it is received. The AI module may utilize machine learning algorithms, such as neural networks or support vector machines, to perform these tasks efficiently.

Unlike traditional messaging systems, the system performs pre-transmission analysis of messaging data (text, voice, image and video). This includes AI-powered natural language processing to: —Detect and block offensive language; —Classify tone/sentiment (optional); and—Decide if the message complies with the application's regulations or context-based rules. This process happens before the message is sent to the recipient, ensuring that only filtered, appropriate voice content is transmitted.

Compared to traditional reviewing system that typically try to detect keywords in a blacklist, the system's thorough filtering review and analysis of offensive and inappropriate language, assures a high-level of message integrity.

The system performs its AI-based analysis and filtering prior not only to message storage or server transmission, but specifically before the message becomes accessible or audible to the recipient. This ensures that potentially inappropriate or unintended content is stopped before reaching the other party, offering an essential control layer absent in typical voice communication systems.

The AI filtering capability within the voice communications system can manifest in various ways, depending on the context and requirements of the interaction. Below are examples of how the AI filtering module can be applied in different scenarios:

Blocking Inappropriate Content: In a customer support environment, the AI filtering module can detect offensive language or profanity in real-time. Upon identification, the system can block the transmission of the inappropriate content, preventing it from reaching the recipient. For instance, if a user attempts to send a message containing explicit language, the AI module can intercept and block the message, ensuring that the communication remains respectful and professional. Terminating the Session: In a social media platform, the AI filtering module can monitor conversations for aggressive or threatening behavior. If such behavior is detected, the system can automatically terminate a live stream to protect users from harassment. For example, if a user exhibits repeated aggressive speech patterns, the AI module can trigger an immediate termination of the session, thereby maintaining a safe communication environment. Classifying Interaction Types: In a call center application, the AI filtering module can classify interactions based on detected sentiment and context. This classification allows the system to route calls to the appropriate department or agent. For instance, if the AI module identifies a conversation as a technical support inquiry, it can automatically direct the call to a technical support specialist, optimizing response times and improving customer satisfaction. Providing Real-Time Feedback: In an educational platform, the AI filtering module can provide real-time feedback to users regarding their communication style. For example, if a student uses unclear or ambiguous language during a voice interaction, the AI module can offer suggestions for improvement, such as rephrasing or clarifying their statements, thereby enhancing the learning experience. Alerting System Administrators: In a corporate communication system, the AI filtering module can generate alerts for system administrators upon detection of repeated behavioral violations. For instance, if a user consistently engages in inappropriate conduct, the AI module can notify administrators, enabling them to take corrective action and maintain a secure communication environment. Translating Voice Messages: In a multilingual business setting, the AI filtering module can translate voice messages in real-time, allowing users who speak different languages to communicate effectively. For example, if a user speaks in Spanish, the AI module can translate the message into English for the recipient, facilitating seamless cross-language interactions.

These examples illustrate the versatility of the AI filtering module in adapting to various communication contexts, enhancing the security, efficiency, and quality of voice interactions across different platforms and industries.

The system is configured to perform filtering and moderation of messaging data entirely on the first user device (sender). This configuration ensures that the message content, including any derivatives or processed forms, remains localized to the initiating device. The processing involves the use of integrated artificial intelligence modules that analyze the message data (either text or converted to text) in real-time, applying sentiment detection, interaction classification, and behavioral moderation directly on the device. By conducting all filtering and moderation processes locally, the system eliminates the need to transmit message content to any intermediary location, thereby preserving user privacy and reducing potential data exposure risks. This approach leverages the device's computational capabilities to execute advanced machine learning algorithms, ensuring efficient and secure moderation without reliance on external servers or cloud-based processing.

One major advantage of the invention is its inherent scalability. By leveraging event-triggered voice activation and short-form PTT transmissions, the system avoids continuous voice streams and significantly reduces server load, enabling a multitude of users to interact concurrently with minimal latency.

In some embodiments, the system's scalability for handling voice messages is achieved through the implementation of a “capsule transmission” model, which facilitates efficient voice communication without the need for extensive infrastructure support. This model leverages short-form, event-triggered voice transmissions that are encapsulated into discrete data packets, or “capsules,” for streamlined processing and delivery.

Each capsule is designed to contain a complete segment of voice data, including metadata for routing and processing, allowing for independent handling and transmission. This encapsulation ensures that each voice segment is self-contained, reducing dependency on continuous data streams and enabling the system to manage multiple concurrent interactions with minimal latency.

The capsule transmission model supports scalability by minimizing the load on network resources and server infrastructure. By encapsulating voice data into compact, manageable units, the system can efficiently route and process communications across diverse network environments, including low-bandwidth or high-latency conditions. This approach allows the system to accommodate a large number of users simultaneously, without requiring significant increases in server capacity or bandwidth allocation.

Furthermore, the capsule transmission model enhances the system's adaptability to various deployment scenarios, including mobile and web-based platforms. The lightweight nature of the capsules enables seamless integration with existing communication frameworks, facilitating cross-platform compatibility and reducing the need for specialized hardware or software modifications.

Overall, the capsule transmission model provides a scalable solution for voice communication, enabling the system to efficiently handle high volumes of interactions while maintaining performance and reliability across diverse operational contexts.

The AI module is designed to detect sentiment within the message data. Sentiment analysis involves the identification of emotional tone and intent within spoken language. For instance, the module may employ natural language processing (NLP) techniques to discern whether the speaker's tone is positive, negative, or neutral. This capability is achieved through the application of pre-trained models that have been exposed to diverse datasets, allowing the system to recognize patterns and infer sentiment accurately.

In addition to sentiment detection, the AI module is capable of classifying interaction types. This classification process involves categorizing messaging interactions based on predefined criteria, such as conversational context or subject matter. For example, the module may distinguish between customer service inquiries and casual conversations by analyzing linguistic cues and contextual information. This classification enhances the system's ability to tailor responses and manage interactions effectively.

The AI module may also enforce behavioral standards by identifying and responding to inappropriate language or behavior. This functionality is achieved through the implementation of rule-based systems or machine learning models trained to recognize specific keywords or phrases indicative of undesirable conduct. Upon detection of such language or behavior, the module can trigger predefined actions, such as issuing warnings or escalating the interaction to human moderators, thereby maintaining a respectful and safe communication environment.

Furthermore, the integration of the AI module into the system enhances both security and efficiency. By automating the monitoring and moderation of messaging data, the system reduces the need for manual oversight, allowing human resources to be allocated to more complex tasks. Additionally, the real-time processing capabilities of the AI module ensure that potential issues are addressed promptly, minimizing the risk of escalation and contributing to a more secure communication process. By embedding AI moderation directly into the messaging pipeline, the system offers built-in voice content safety without requiring human intervention or post-reporting systems. This is critical for applications where harassment or spam is common (e.g., dating, ride-sharing, or gaming).

In some embodiments, the AI module can provide real-time language translation, wherein the message sender and recipient speak different languages, and the system translates and dubs each message in real-time, from the language of the sender to the language of the receiver. As used herein, “real-time” refers to processing or communication that occurs with a delay that is sufficiently short to allow for effective or perceived immediate interaction or responsiveness, given the context of the application. The AI module continuously monitors user conversations, providing real-time feedback and moderation as necessary.

The system is configured to maintain user privacy by ensuring that no phone numbers or personal contact information are transmitted during interactions. For example, the system may utilize anonymized identifiers or encrypted tokens to facilitate communication between devices, thereby preventing the exposure of sensitive user data. Additionally, the system incorporates context-aware activation capabilities, which may include the use of geofencing technology or temporal triggers. Geofencing technology allows the system to activate signal transmission when a user enters or exits a predefined geographic area, utilizing GPS or other location-based services. Temporal triggers may be employed to initiate signal transmission at specific times or in response to scheduled events. These features enhance the system's applicability across various use cases and industries, such as retail, where location-based promotions can be delivered to users, or in logistics, where time-sensitive notifications are critical.

The communication module may utilize Global Positioning System (GPS) technology or other location-based services to determine the precise geographic coordinates of the user. This information is processed in real-time to assess whether the user is within a predefined geographic boundary or geofence. The geofence may be established based on specific operational requirements, such as proximity to a delivery location, a service area, or a designated meeting point.

For instance, in a delivery service application, the system can be configured to activate a PTT signal transmission only when the delivery personnel are within a certain radius of the customer's location. This ensures that communication is initiated only when it is contextually relevant, thereby reducing unnecessary interactions and enhancing operational efficiency.

The communication module may also incorporate a location-based rule engine that defines the conditions under which signal transmission is permitted. These conditions can be dynamically adjusted based on factors such as time of day, user preferences, or specific event triggers. For example, the system may allow signal transmission during business hours or when a user enters a specific zone, such as a retail store or event venue.

Additionally, the system may employ location-based notifications to inform users when they are entering or exiting a geofenced area. These notifications can serve as prompts for users to initiate or prepare for PTT communication, ensuring timely and relevant interactions.

The integration of geographic location-based activation within the communication module not only enhances the system's adaptability to various use cases but also contributes to a more efficient and user-friendly communication experience. By leveraging real-time location data, the system can provide targeted and context-aware communication capabilities, aligning with the operational needs of diverse industries such as logistics, retail, and field services.

The system described herein is configured to activate signal transmission based on predefined event timing, which enhances the contextual relevance and efficiency of the push-to-talk (PTT) communication process. This feature leverages temporal triggers to ensure that communication is initiated only when it is operationally pertinent.

The communication module may incorporate a timing engine that defines specific conditions under which signal transmission is permitted. These conditions can be dynamically adjusted based on factors such as user preferences, operational requirements, or specific event triggers. The timing engine may utilize a combination of hardware and software components to monitor and evaluate temporal conditions in real-time.

For instance, in a delivery service application, the system can be configured to activate a PTT signal transmission at a predefined time before the estimated time of arrival (ETA) at the delivery location. This ensures that communication is initiated only when it is contextually relevant, thereby reducing unnecessary interactions and enhancing operational efficiency. The timing engine may utilize algorithms to calculate the ETA based on real-time traffic data and route information, ensuring accurate timing for signal activation.

In another example, the system may be configured to activate signal transmission during specific business hours or operational windows. For instance, in a customer support scenario, the PTT communication may be enabled only during the hours when support agents are available, ensuring that user interactions are timely and relevant. The timing engine may interface with a scheduling system to retrieve and apply operational hours, dynamically adjusting the activation conditions as needed.

Additionally, the system may employ event-based triggers to activate signal transmission in response to specific occurrences. For example, in a logistics application, the PTT communication may be activated when a delivery vehicle reaches a certain checkpoint or milestone along its route. The timing engine may utilize geofencing technology or sensor data to detect these events, ensuring that communication is initiated at the appropriate time.

The integration of predefined event timing within the communication module not only enhances the system's adaptability to various use cases but also contributes to a more efficient and user-friendly communication experience. By leveraging real-time temporal data, the system can provide targeted and context-aware communication capabilities, aligning with the operational needs of diverse industries such as logistics, customer support, and field services.

The system comprises an artificial intelligence filtering module configured to analyze message data (analyzing text messages, or text conversions of non-text messages) in real-time to detect sentiment within the conversation. This module is integrated into the communication system to facilitate the continuous monitoring and evaluation of text, audio, images and video inputs. The AI module employs advanced natural language processing (NLP) techniques to assess the emotional tone and intent of spoken language, enabling the system to discern whether the speaker's sentiment is positive, negative, or neutral.

The sentiment detection process involves several technical components and methodologies. The AI module utilizes pre-trained machine learning models, such as recurrent neural networks (RNNs) or convolutional neural networks (CNNs), which have been exposed to extensive datasets containing diverse linguistic patterns and emotional expressions. These models are capable of recognizing subtle nuances in speech, allowing for accurate sentiment classification.

For instance, the AI module may implement a sentiment analysis algorithm that processes audio data by first converting it into text using automatic speech recognition (ASR) technology. The transcribed text is then analyzed using sentiment lexicons or word embeddings, such as Word2Vec or GloVe, to identify sentiment-bearing words and phrases. The module may also incorporate context-aware sentiment analysis, which considers the surrounding conversational context to enhance the accuracy of sentiment detection.

In practical applications, the AI module's sentiment detection capabilities can be utilized to improve user experience and interaction quality. For example, in a customer support scenario, the system can identify when a user is expressing frustration or dissatisfaction, prompting the system to escalate the interaction to a human agent for resolution. Similarly, in a social communication platform, the module can detect positive sentiment, such as enthusiasm or agreement, and adjust the interaction flow accordingly to maintain engagement.

The integration of real-time sentiment analysis within the communication system not only enhances the system's ability to respond to user emotions but also contributes to a more secure and respectful communication environment. By continuously monitoring sentiment, the system can proactively address potential issues, such as escalating conflicts or misunderstandings, thereby fostering a positive interaction experience for all users.

The system comprises an artificial intelligence filtering module configured to analyze messaging data in real-time, enabling the classification of interaction types based on detected sentiment. This classification process involves the use of advanced natural language processing (NLP) techniques and machine learning algorithms to categorize messaging interactions according to predefined criteria, such as conversational context, emotional tone, or subject matter.

For instance, the AI module may employ recurrent neural networks (RNNs) or convolutional neural networks (CNNs) trained on extensive datasets to recognize patterns in speech that correspond to specific interaction types. These models are capable of processing messaging inputs to identify linguistic cues and contextual information, allowing the system to distinguish between various categories of communication, such as customer service inquiries, casual conversations, or technical support requests.

In a practical application, the AI module may utilize automatic speech recognition (ASR) technology to convert audio data into text, which is then analyzed using sentiment lexicons or word embeddings like Word2Vec or GloVe. This analysis enables the system to detect sentiment-bearing words and phrases, facilitating the classification of interactions based on the emotional tone and intent of the speaker.

For example, in a customer support scenario, the system can classify interactions as either complaint-related or inquiry-based, depending on the detected sentiment and context. This classification allows the system to route interactions to the appropriate department or agent, optimizing response times and improving user satisfaction.

Additionally, the AI module's ability to classify interaction types enhances the system's capacity to tailor responses and manage interactions effectively. By understanding the nature of the communication, the system can provide contextually relevant feedback or escalate interactions when necessary, ensuring a more efficient and personalized user experience.

The integration of real-time interaction classification within the communication system not only improves operational efficiency but also contributes to a more secure and respectful communication environment. By continuously monitoring and categorizing interactions, the system can proactively address potential issues, such as escalating conflicts or misunderstandings, thereby fostering a positive interaction experience for all users.

In some embodiments, a buffer zone component can be designed to facilitate the off-device processing of digital messages while maintaining the integrity and security of the message content prior to transmission. The buffer zone serves as an intermediary storage and processing area where digital messages are temporarily held and analyzed before being sent to the recipient. This approach allows for comprehensive moderation and filtering of content, ensuring that only approved messages are transmitted.

### Implementation of the Buffer Zone:

Local Device Buffering: In one embodiment, the buffer zone is implemented as a local storage area within the sender's device. This storage area is configured to temporarily hold digital messages, such as voice or video data, captured by the device's input modules. The buffer is managed by a dedicated software component that interfaces with the device's operating system to allocate memory resources efficiently. The local buffer is equipped with encryption capabilities to secure the stored data, ensuring that it remains protected from unauthorized access during the moderation process. The encryption may utilize advanced cryptographic algorithms, such as AES (Advanced Encryption Standard), to safeguard the data. Cloud-Based Buffering: In another embodiment, the buffer zone is implemented as a cloud-based service, where digital messages are uploaded to a secure server for processing. This approach leverages cloud computing resources to perform intensive analysis tasks, such as sentiment detection and content classification, without burdening the sender's device. The cloud-based buffer is designed to handle large volumes of data, providing scalability and flexibility for applications with high user traffic. Data transmission to and from the cloud buffer is secured using end-to-end encryption protocols, such as TLS (Transport Layer Security), to maintain data confidentiality and integrity. Hybrid Buffering System: A hybrid approach combines local and cloud-based buffering, where initial processing occurs on the sender's device, and more complex analysis is offloaded to the cloud. This system optimizes resource utilization by performing lightweight tasks locally and reserving cloud resources for computationally demanding operations. The hybrid buffer system can dynamically adjust the processing location based on network conditions, device capabilities, and user preferences, ensuring optimal performance and user experience.

### Advantages of the Buffer Zone:

Enhanced Security and Privacy: By processing digital messages in a buffer zone before transmission, the system ensures that sensitive content is not exposed to recipients until it has been thoroughly vetted. This pre-transmission analysis prevents the dissemination of inappropriate or harmful content, protecting both the sender and recipient. The use of encryption within the buffer zone further enhances security, ensuring that data remains confidential and tamper-proof during the moderation process. Improved Moderation Accuracy: The buffer zone allows for comprehensive analysis of digital messages using advanced AI algorithms. By holding messages temporarily, the system can perform detailed sentiment analysis, content classification, and behavioral assessment, leading to more accurate moderation outcomes. The ability to process messages off-device enables the use of sophisticated machine learning models that require significant computational power, improving the system's ability to detect nuanced content issues. Scalability and Flexibility: The buffer zone architecture supports scalable processing, accommodating varying levels of user activity and data volume. Cloud-based buffering, in particular, provides the elasticity needed to handle peak loads without compromising performance. The system's flexibility allows for customization of moderation criteria and processing workflows, enabling adaptation to different application contexts and user requirements. Reduced Latency and Resource Utilization: By performing initial processing locally, the buffer zone reduces the need for constant data transmission to external servers, minimizing network latency and bandwidth usage. This approach is particularly beneficial in environments with limited connectivity or high data costs. The hybrid buffering model optimizes resource allocation, ensuring that device and network resources are used efficiently, enhancing overall system performance.

In summary, the buffer zone is a versatile and secure component that facilitates the effective moderation of digital messages, ensuring that only compliant content is transmitted to recipients. Its implementation across local, cloud-based, and hybrid systems provides a robust framework for maintaining communication integrity and user privacy.

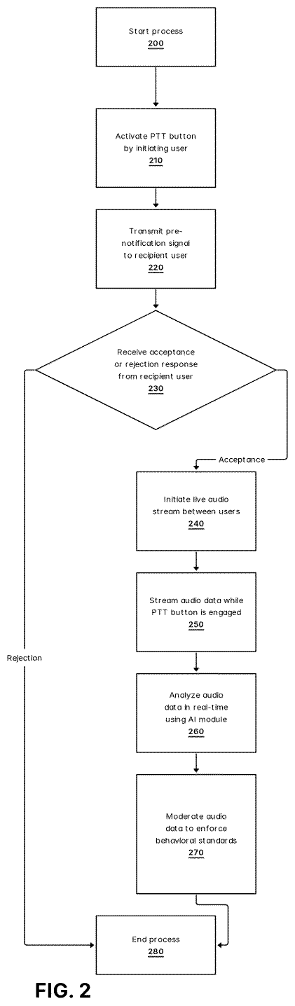

FIG. 2 shows a flowchart illustrating the process of the Smart AI Push Interaction (SAPI) protocol. The process begins at step 200, where the system initiates the communication sequence. At step 210, the initiating user activates the Push-to-Talk (PTT) button, signaling the desire to communicate.

Following activation, step 220 involves transmitting a pre-notification signal to the recipient user, alerting them of the incoming communication request. At step 230, the system receives either an acceptance or rejection response from the recipient user. If the recipient accepts, the process proceeds to step 240, where a live audio stream is initiated between the users.

During step 250, audio data is streamed while the PTT button remains engaged by the initiating user. Concurrently, at step 260, the audio data is analyzed in real-time using an AI module. This analysis is crucial for maintaining the integrity of the communication.

At step 270, the system moderates the audio data to enforce behavioral standards, ensuring compliance with predefined communication protocols. The process concludes at step 280, where the communication session is terminated, marking the end of the process.

In another aspect, the present invention relates to a method for facilitating voice communication between users comprises several steps, beginning with the transmission of a pre-notification signal to a recipient user upon activation of a push-to-talk (PTT) button by an initiating user. This pre-notification signal is transmitted without establishing a communication channel, allowing the recipient user to decide whether to accept or reject the communication request.

Upon receiving an acceptance response from the recipient user, a live audio stream is initiated between the initiating user and the recipient user. The audio data is streamed from the initiating user to the recipient user while the PTT button remains engaged, contingent upon the acceptance response. This ensures that the communication is consent-based and controlled by the recipient.

The method further includes the real-time analysis of the audio or any messaging data using an artificial intelligence filtering module. This module is configured to detect sentiment within the conversation and classify interaction types based on the detected sentiment. The AI module employs advanced natural language processing (NLP) techniques and machine learning algorithms, such as recurrent neural networks (RNNs) or convolutional neural networks (CNNs), to perform these tasks efficiently.

In addition to sentiment detection and interaction classification, the method involves moderating the audio or any messaging data in real-time to enforce behavioral standards. This is achieved by identifying and responding to inappropriate language or behavior. The AI module may utilize rule-based systems or machine learning models trained to recognize specific keywords or phrases indicative of undesirable conduct. Upon detection of such language or behavior, the system can trigger predefined actions, such as issuing warnings or escalating the interaction to human moderators, thereby maintaining a respectful and safe communication environment.

The described method is applicable in various communication systems, including mobile applications and web-based platforms, where users can engage in push-to-talk (PTT) communication via a user-friendly interface. The system is designed to maintain user privacy by ensuring that no phone numbers or personal contact information are transmitted during interactions. This approach enhances security and efficiency in digital interactions, providing a flexible and context-aware solution for voice communication.

The described systems and methods are applicable to push-to-talk (PTT) interactions, any voice messaging flow, and any messaging flow (text, voice, images, video)—including one-to-one, group messaging, or any asynchronous voice communication—wherein audio content is captured and temporarily held (buffered) prior to transmission or exposure to any recipient or endpoint, allowing for AI-based pre-send moderation, and transmission or rendering of the audio is performed only upon approval by the filtering mechanism, wherein the holding mechanism may further be used for additional processing such as manual review, audio transformation, language translation, delayed sending, or other content adaptations prior to transmission.

In another aspect, the present invention relates to a system for moderating pre-recorded or live digital messages prior to their transmission to a recipient comprising several key components, each designed to ensure the integrity and compliance of the messages with predefined behavioral standards. The system includes a recording module, a moderation module, an authorization module, and a transmission module.

### Recording Module:

The recording module is configured to capture and store digital messages from a sender. This module may be implemented using a combination of hardware and software components. For instance, the module can utilize a microphone or camera to capture audio or video data, which is then digitized and stored in a local or cloud-based storage system. The storage system may employ data compression techniques to optimize space utilization and ensure efficient retrieval of the stored messages.

In one embodiment, the recording module is integrated into a mobile application, allowing users to record voice messages directly from their smartphones. The application may provide a user-friendly interface with controls for starting, pausing, and stopping the recording process. The recorded messages are then stored in a secure format, such as an encrypted file, to protect the content from unauthorized access.

### Moderation Module:

The moderation module is responsible for analyzing the stored digital messages using artificial intelligence classification techniques. This module employs machine learning algorithms, such as neural networks or support vector machines, to detect inappropriate content, sentiment, and interaction types. The algorithms are trained on extensive datasets that include examples of various categories of inappropriate content, such as hate speech, harassment, and discriminatory language.

In one embodiment, the moderation module is implemented as a cloud-based service, where the recorded messages are uploaded for analysis. The service utilizes high-performance computing resources to perform complex analysis tasks, such as sentiment detection and content classification. The module may also incorporate natural language processing (NLP) techniques to evaluate the linguistic and contextual attributes of the messages, enhancing the accuracy of the moderation process.

### Authorization Module:

The authorization module is configured to approve or reject the digital messages based on the analysis performed by the moderation module. This module ensures compliance with predefined behavioral standards by evaluating the results of the moderation analysis. If the message is deemed appropriate, the authorization module grants approval for transmission. Conversely, if the message contains inappropriate content, the module rejects the transmission request.

In one embodiment, the authorization module is integrated into the moderation service, allowing for seamless communication between the analysis and decision-making processes. The module may utilize rule-based systems to define the criteria for approval or rejection, ensuring consistent enforcement of communication policies.

### Transmission Module:

The transmission module is responsible for transmitting the approved digital messages to the recipient. This module may be implemented using various network protocols, such as Transmission Control Protocol (TCP) or User Datagram Protocol (UDP), to ensure reliable and efficient delivery of the messages. The module may also incorporate encryption techniques to secure the data during transmission, protecting it from interception or tampering.

In one embodiment, the transmission module is part of a mobile application, enabling users to send approved messages directly from their devices. The application may provide options for selecting recipients and managing message delivery, ensuring a user-friendly experience.

### Examples and Embodiments:

Mobile Application Integration: In a mobile application, the system can be implemented to allow users to record voice messages, which are then analyzed by the moderation module. The authorization module evaluates the analysis results, and approved messages are transmitted to the recipient via the application's messaging platform. This embodiment provides a seamless user experience, with real-time feedback on message compliance. Cloud-Based Moderation Service: A cloud-based service can be employed to handle the moderation and authorization processes. Users upload their recorded messages to the cloud, where the moderation module performs analysis using advanced AI techniques. The authorization module then determines message compliance, and approved messages are transmitted to recipients through a secure network connection. This embodiment offers scalability and flexibility, accommodating high volumes of user activity. Enterprise Communication System: In an enterprise setting, the system can be integrated into corporate communication platforms to ensure that all digital messages comply with organizational policies. The moderation module analyzes messages for inappropriate content, and the authorization module enforces compliance standards. Approved messages are transmitted through the enterprise network, ensuring secure and policy-compliant communication.

These embodiments illustrate the versatility and effectiveness of the system in moderating digital messages, ensuring that only compliant content is transmitted to recipients while maintaining security and user privacy.

In some embodiments, the system is configured to perform real-time analysis and moderation of voice messages using an artificial intelligence (AI) module. This process involves several technical features and methodologies to ensure that the analysis and moderation are conducted efficiently and effectively.

The AI module is integrated into the system architecture to facilitate continuous monitoring and evaluation of text, audio, images and video inputs. It employs advanced natural language processing (NLP) techniques and machine learning algorithms to analyze the content of voice messages as they are captured. The module utilizes automatic speech recognition (ASR) technology to convert audio data (of voice, or audio portion of a video) into text, enabling further analysis of linguistic and contextual attributes.

The real-time analysis process for audio (voice) signals begins with the capture of voice data through the system's microphone/audio module. The captured audio is immediately digitized and processed by the AI module. The module employs pre-trained machine learning models, such as recurrent neural networks (RNNs) or convolutional neural networks (CNNs), which have been trained on extensive datasets to recognize patterns indicative of inappropriate content, sentiment, and interaction types.

For instance, the AI module may implement a sentiment analysis algorithm that evaluates the emotional tone of the transcribed text. This involves the use of sentiment lexicons or word embeddings, such as Word2Vec or GloVe, to identify sentiment-bearing words and phrases. The module can detect whether the speaker's tone is positive, negative, or neutral, allowing for the classification of interactions based on the detected sentiment.

In addition to sentiment detection, the AI module is capable of identifying specific categories of inappropriate content, such as hate speech, harassment, or discriminatory language. This is achieved through the application of rule-based systems or machine learning models trained to recognize specific keywords or phrases indicative of undesirable conduct. Upon detection of such content, the module can trigger predefined actions, such as issuing warnings or escalating the interaction to human moderators.

The moderation process is conducted in real-time, ensuring that any inappropriate content is identified and addressed promptly. The AI module continuously monitors the audio stream, providing real-time feedback to users regarding detected inappropriate behavior. This feedback may include visual or auditory alerts, allowing users to adjust their communication style accordingly.

The integration of real-time analysis and moderation within the communication system not only enhances the system's ability to respond to user emotions but also contributes to a more secure and respectful communication environment. By continuously monitoring sentiment and content, the system can proactively address potential issues, such as escalating conflicts or misunderstandings, thereby fostering a positive interaction experience for all users.

The system for moderating digital messages incorporates a moderation module configured to detect categories of inappropriate content, including but not limited to hate speech, harassment, sexual abuse, racism, self-harm, bullying, threats of violence, and discriminatory language. This detection is achieved through the utilization of machine learning algorithms trained on datasets representative of these categories.

### Implementation of the Moderation Module:

Machine Learning Algorithms: The moderation module employs advanced machine learning algorithms, such as convolutional neural networks (CNNs) and recurrent neural networks (RNNs), to analyze digital messages. These algorithms are trained on extensive datasets that include examples of various categories of inappropriate content. The training process involves exposing the models to labeled data, allowing them to learn patterns and features associated with each category of content. For instance, a CNN may be used to process audio spectrograms, identifying acoustic features indicative of aggressive or threatening speech. An RNN, on the other hand, may analyze the temporal sequence of words in a text transcript to detect patterns of harassment or bullying. Natural Language Processing (NLP) Techniques: The moderation module integrates NLP techniques to enhance the analysis of linguistic and contextual attributes of digital messages. Techniques such as sentiment analysis, named entity recognition, and part-of-speech tagging are employed to extract meaningful information from text data. These techniques enable the system to understand the context and intent behind the words, improving the accuracy of content classification. For example, sentiment analysis can identify negative emotional tones in a message, while named entity recognition can detect references to specific individuals or groups, which may be relevant in cases of targeted harassment or discrimination. Contextual Analysis: The moderation module conducts contextual analysis by evaluating the linguistic, acoustic, and behavioral attributes of the speaker. This involves considering the surrounding context of the message, such as previous interactions, user history, and environmental factors. By incorporating contextual information, the system can make more informed decisions about the appropriateness of the content. In one embodiment, the system may utilize a context-aware model that adjusts its analysis based on the user's interaction history. For instance, if a user has a history of using offensive language, the system may apply stricter moderation criteria to their messages.

### Examples and Embodiments:

Real-Time Voice Moderation: In a live voice communication scenario, the moderation module can analyze audio data in real-time to detect inappropriate content. The system may employ a combination of acoustic feature extraction and NLP techniques to identify harmful speech patterns. Upon detection, the system can issue warnings to the user or automatically terminate the communication session to prevent the transmission of inappropriate content. Multilingual Content Analysis: The moderation module can be configured to support multilingual content analysis, allowing it to detect inappropriate content in multiple languages. This is achieved by training the machine learning models on multilingual datasets and incorporating language-specific NLP techniques. For example, the system may use language detection algorithms to identify the language of a message and apply the appropriate analysis model. Adaptive Moderation: The system can implement adaptive moderation by locally adjusting the classification of digital messages based on user behavior or feedback. This involves continuously updating the moderation criteria based on user interactions and feedback, allowing the system to adapt to changing communication norms and user preferences. For instance, if a user consistently provides feedback that certain content is misclassified, the system can adjust its analysis parameters to improve accuracy.

These embodiments illustrate the versatility and effectiveness of the moderation module in detecting and managing inappropriate content across various communication contexts, ensuring that digital messages comply with predefined behavioral standards while maintaining security and user privacy.

The moderation module conducts contextual analysis by evaluating linguistic, acoustic, and behavioral attributes of the speaker. This involves assessing the surrounding context of the message, such as prior interactions and user history, to enhance the precision in identifying harmful speech. The module utilizes machine learning models trained to recognize patterns indicative of inappropriate content, allowing for nuanced detection and classification. By incorporating contextual information, the system can make informed decisions about the appropriateness of the content, improving the accuracy of moderation outcomes.

In some embodiments, the system is configured to locally adjust the classification of digital messages based on user behavior or feedback, enabling adaptive moderation without necessitating remote model retraining. This feature is implemented through a dynamic feedback loop that continuously refines the moderation criteria in response to user interactions and feedback.

### Implementation of Adaptive Moderation:

Local Feedback Integration: The system incorporates a feedback mechanism that allows users to provide input on the accuracy of content classification. This feedback is collected through the user interface, where users can indicate whether a message was correctly classified or if adjustments are needed. The feedback is processed locally on the user's device, ensuring that the system can adapt in real-time without relying on external servers. Behavioral Analysis Module: A behavioral analysis module is integrated into the system to monitor user interactions and identify patterns that may influence content classification. This module utilizes machine learning algorithms to analyze user behavior, such as message frequency, tone, and context. By understanding these patterns, the system can adjust its classification criteria to better align with the user's communication style and preferences. Contextual Adaptation: The system employs contextual adaptation techniques to refine content classification based on the specific context of the interaction. This involves analyzing the linguistic and situational context of messages to determine the most appropriate classification criteria. For example, the system may adjust its sensitivity to certain keywords or phrases based on the user's past interactions or the current conversation topic.

### Examples and Embodiments:

Personalized Moderation in Social Media: In a social media application, the system can adapt its moderation criteria based on user feedback and behavior. For instance, if a user frequently engages in discussions about sensitive topics, the system may adjust its classification thresholds to allow for more nuanced conversations. This personalized approach ensures that users can communicate freely while maintaining compliance with platform policies. Enterprise Communication Platforms: In an enterprise setting, the system can be configured to adapt its moderation criteria based on organizational feedback and communication norms. For example, if a company has specific guidelines for professional communication, the system can adjust its classification criteria to enforce these standards. This ensures that all digital messages align with the organization's policies while allowing for flexibility in communication styles. Educational Environments: In educational platforms, the system can adapt its moderation criteria to support diverse learning environments. For instance, if a classroom encourages open discussions on controversial topics, the system can adjust its classification criteria to accommodate these conversations while still identifying and addressing inappropriate content. This adaptive approach fosters a supportive learning environment while maintaining a respectful communication standard.

These embodiments demonstrate the system's ability to dynamically adjust content classification based on user behavior and feedback, enhancing the accuracy and relevance of moderation outcomes across various communication contexts.

In another aspect, the present invention relates to a method for moderating pre-recorded or live digital messages prior to their transmission to a recipient involves several technical components and processes to ensure compliance with predefined behavioral standards. The method begins with capturing and storing digital messages from a sender using a recording module. This module may be implemented as a software application on a mobile device or computer, equipped with a microphone or camera to capture audio or video data. The captured data is digitized and stored in a secure format, such as an encrypted file, to protect the content from unauthorized access.

The stored digital messages are then analyzed by a moderation module employing artificial intelligence classification techniques. This module utilizes machine learning algorithms, such as convolutional neural networks (CNNs) and recurrent neural networks (RNNs), to detect inappropriate content, sentiment, and interaction types. The algorithms are trained on extensive datasets that include examples of various categories of inappropriate content, such as hate speech, harassment, and discriminatory language. The moderation module may also incorporate natural language processing (NLP) techniques to evaluate the linguistic and contextual attributes of the messages, enhancing the accuracy of the analysis.

Once the analysis is complete, an authorization module evaluates the results to approve or reject the digital messages. This module ensures compliance with predefined behavioral standards by applying rule-based systems to define the criteria for approval or rejection. If the message is deemed appropriate, the authorization module grants approval for transmission. Conversely, if the message contains inappropriate content, the module rejects the transmission request.

The approved digital messages are then transmitted to the recipient via a transmission module. This module may utilize various network protocols, such as Transmission Control Protocol (TCP) or User Datagram Protocol (UDP), to ensure reliable and efficient delivery of the messages. The transmission module may also incorporate encryption techniques to secure the data during transmission, protecting it from interception or tampering.

In one embodiment, the method is applied in a mobile application where users can record voice messages. The moderation module analyzes the messages in real-time, providing immediate feedback on compliance. The authorization module evaluates the analysis results, and approved messages are transmitted to the recipient via the application's messaging platform.

In another embodiment, the method is implemented in a cloud-based service, where users upload their recorded messages for analysis. The moderation module performs the analysis using advanced AI techniques, and the authorization module determines message compliance. Approved messages are transmitted to recipients through a secure network connection, offering scalability and flexibility for applications with high user traffic.

In an enterprise communication system, the method ensures that all digital messages comply with organizational policies. The moderation module analyzes messages for inappropriate content, and the authorization module enforces compliance standards. Approved messages are transmitted through the enterprise network, ensuring secure and policy-compliant communication.

These embodiments illustrate the versatility and effectiveness of the method in moderating digital messages, ensuring that only compliant content is transmitted to recipients while maintaining security and user privacy.

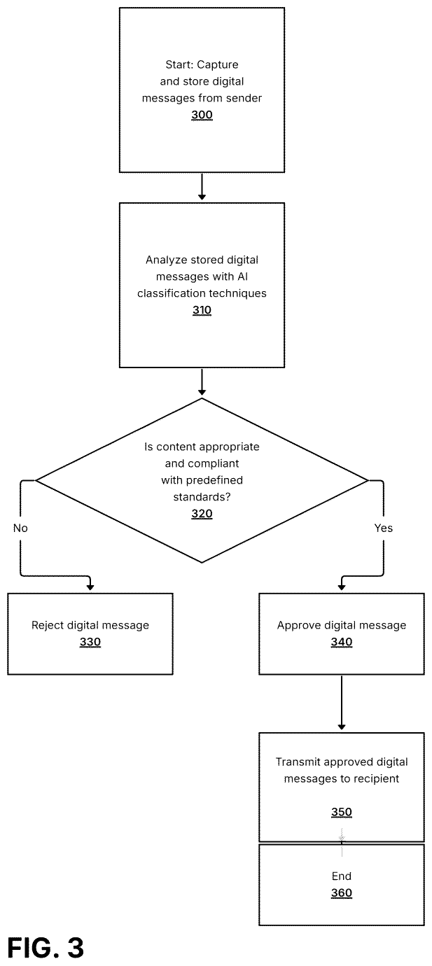

FIG. 3 shows a flowchart detailing the process for moderating digital messages within the SAPI system. At step 300, digital messages from the sender are captured and stored. This initial step ensures that the messages are available for subsequent analysis and processing.

At step 310, the stored digital messages undergo analysis using AI classification techniques. This analysis is designed to evaluate the content of the messages, identifying key attributes such as sentiment and compliance with predefined standards.

Step 320 involves a decision point where the system determines whether the content is appropriate and compliant with the predefined standards. If the content is deemed inappropriate, the process moves to step 330, where the digital message is rejected. This rejection prevents the transmission of messages that do not meet the required criteria.

Conversely, if the content is found to be appropriate, the process advances to step 340, where the digital message is approved. Following approval, step 350 involves transmitting the approved digital messages to the recipient, ensuring that only compliant content is delivered.

Finally, the process concludes at step 360, marking the end of the message moderation and transmission sequence. This structured approach ensures that all digital communications within the SAPI system are moderated effectively, maintaining the integrity and security of interactions.

In some embodiments, the system is configured to facilitate the moderation of video streams by segmenting the stream into incremental portions and analyzing each portion for compliance with predefined behavioral standards. This process involves several technical components and methodologies to ensure efficient and effective moderation. The term “video stream” as referred herein, means both a live video stream and a pre-recorded video stream.

The system comprises a video capture module configured to receive live video input from a sender's device. This module utilizes the device's camera to capture video data, which is then digitized and prepared for processing. The video capture module may employ video compression techniques, such as H.264 or VP9, to optimize the data for transmission and analysis.

Once the video data is captured, the system employs a segmentation module to divide the video stream into incremental portions. The segmentation process is governed by predefined criteria, which may include temporal parameters, such as fixed time intervals (e.g., every 5 seconds), or event-based triggers, such as changes in scene or detected motion. The segmentation module utilizes algorithms to detect these criteria, ensuring that each portion is appropriately defined for subsequent analysis.

The segmented video portions are then processed by an artificial intelligence (AI) moderation module, which is configured to analyze each portion in real-time. The AI module employs machine learning algorithms, such as convolutional neural networks (CNNs), to evaluate the visual and auditory content of each segment. These algorithms are trained on extensive datasets to recognize patterns indicative of inappropriate content, such as violence, nudity, or hate symbols.

The AI moderation module also incorporates natural language processing (NLP) techniques to analyze any audio components within the video segments. This analysis involves converting audio data into text using automatic speech recognition (ASR) technology, followed by sentiment analysis to detect inappropriate language or tone.

Upon completion of the analysis, the AI moderation module determines whether each video segment complies with the predefined behavioral standards. If a segment is deemed appropriate, it is approved for transmission to the recipient. Conversely, if a segment contains inappropriate content, the module may block its transmission, issue warnings to the sender, or escalate the issue to human moderators for further review.

The system's ability to segment and analyze video streams in real-time ensures that only compliant content is transmitted to recipients, maintaining a secure and respectful communication environment. This approach allows for dynamic moderation of live interactions, providing immediate feedback and intervention when necessary. The segmentation and moderation processes are designed to operate efficiently, minimizing latency and ensuring a seamless user experience.

In the context of the metaverse environment, the method for moderating digital messages prior to their transmission to a recipient involves several technical features and processes to ensure compliance with predefined behavioral standards specific to the metaverse. The method begins with capturing and storing digital messages from a sender using a recording module. This module may be implemented as a software application within the metaverse platform, equipped with virtual input devices to capture audio or video data from avatars. The captured data is digitized and stored in a secure format, such as an encrypted file, to protect the content from unauthorized access.

The stored digital messages are then analyzed by a moderation module employing artificial intelligence classification techniques. This module utilizes machine learning algorithms, such as convolutional neural networks (CNNs) and recurrent neural networks (RNNs), to detect inappropriate content, sentiment, and interaction types. The algorithms are trained on extensive datasets that include examples of various categories of inappropriate content, such as hate speech, harassment, and discriminatory language, tailored to the metaverse context. The moderation module may also incorporate natural language processing (NLP) techniques to evaluate the linguistic and contextual attributes of the messages, enhancing the accuracy of the analysis.

Once the analysis is complete, an authorization module evaluates the results to approve or reject the digital messages. This module ensures compliance with predefined behavioral standards by applying rule-based systems to define the criteria for approval or rejection. If the message is deemed appropriate, the authorization module grants approval for transmission. Conversely, if the message contains inappropriate content, the module rejects the transmission request.

The approved digital messages are then transmitted to the recipient via a transmission module. This module may utilize various network protocols, such as Transmission Control Protocol (TCP) or User Datagram Protocol (UDP), to ensure reliable and efficient delivery of the messages within the metaverse environment. The transmission module may also incorporate encryption techniques to secure the data during transmission, protecting it from interception or tampering.

In the metaverse environment, the method further includes enforcing social and communication policies in real time during avatar communication within a shared virtual space. The moderation module analyzes digital messages to ensure compliance with predefined behavioral standards specific to the metaverse environment, such as virtual conduct guidelines and community norms. The system dynamically adjusts the communication flow based on detected policy violations, providing real-time feedback to users and maintaining a respectful and secure virtual interaction space.

The integration of these technical features within the metaverse environment not only enhances the system's ability to respond to user emotions and conduct but also contributes to a more secure and respectful communication environment. By continuously monitoring sentiment and content, the system can proactively address potential issues, such as escalating conflicts or misunderstandings, thereby fostering a positive interaction experience for all users within the metaverse.

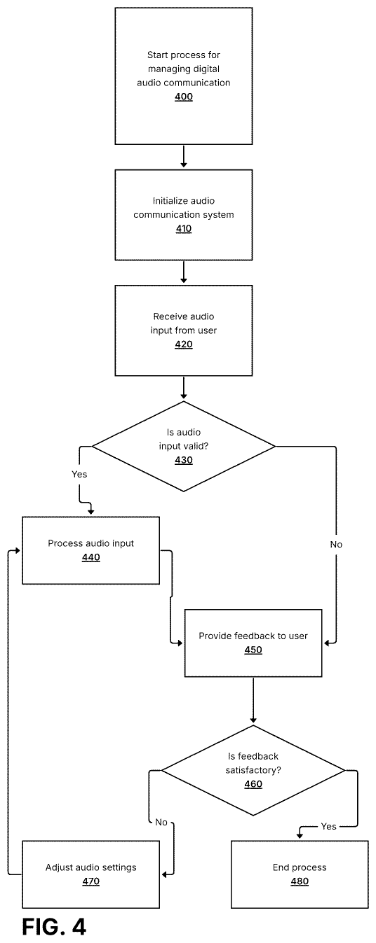

FIG. 4 shows a flowchart detailing the process for managing digital audio communication. At step 400, the process for managing digital audio communication is initiated. This step sets the stage for subsequent actions within the system.

At step 410, the audio communication system is initialized. This involves setting up the necessary components and configurations to handle audio input effectively. Following initialization, step 420 involves receiving audio input from the user, capturing the audio signals for further processing.

Step 430 determines whether the audio input is valid. If the input is deemed valid, the process proceeds to step 440, where the audio input is processed. This processing may involve analyzing the audio for quality, content, or other relevant parameters.

If the audio input is not valid, the system moves to step 450, where feedback is provided to the user. This feedback may include information on why the input was invalid or suggestions for improvement. The process then evaluates at step 460 whether the feedback is satisfactory. If the feedback is not satisfactory, the system proceeds to step 470, where audio settings are adjusted to improve input quality or validity.

If the feedback is satisfactory, or after adjustments are made, the process concludes at step 480, where the process is ended. This step signifies the completion of the audio communication management cycle, ensuring that the system is ready for future interactions.

In another aspect, the present disclosure pertains to a method for managing digital communication involving several technical components and processes to ensure efficient and secure transmission of messaging data through a push-to-talk interface. The method is implemented on a user device equipped with a processor and a memory, which are configured to execute a local analysis module.

The process begins with the user device capturing messaging data through the push-to-talk interface. This interface may be a physical button or a virtual control on a touchscreen, allowing the user to initiate communication. The captured messaging data, which may include text, voice, image, or video, is then processed by the local analysis module, which is stored in the device's memory and executed by the processor.

The local analysis module employs a recognition model to convert the messaging data into a standardized format. For voice data, this model may be based on neural network architectures, such as recurrent neural networks (RNNs) or convolutional neural networks (CNNs), which are trained to accurately transcribe spoken language into text. For image and video data, the model may utilize image recognition techniques to extract relevant information. The conversion process involves analyzing the features of the messaging data, such as tone, pitch, volume, and visual elements, to ensure accurate transcription and interpretation.

Once the messaging data is converted into a standardized format, the content analysis component of the local analysis module performs a detailed examination of the data. This analysis includes parsing the data to identify specific keywords, applying natural language processing (NLP) techniques to determine sentiment, and evaluating the context using a predefined lexicon. The NLP techniques may involve sentiment analysis algorithms that assess the emotional tone of the text, identifying whether the sentiment is positive, negative, or neutral.

The decision-making algorithm, which is part of the local analysis module, utilizes the results of the content analysis to determine whether to transmit or block the messaging data in real-time. This algorithm incorporates a set of predefined rules and criteria, which may include identifying harmful, offensive, policy-violating, misleading, inappropriate, or unauthorized content. The decision-making process is designed to ensure that only compliant and appropriate messaging data is transmitted to the recipient.

In some embodiments, the method includes a feature that allows the user to review flagged messages before transmission. If the content analysis identifies potential issues, the message is flagged, and the user is notified of the reason for flagging. The user interface provides options for the user to either confirm the transmission or cancel the message entirely. This feature enhances user control and ensures that the final decision to transmit rests with the user.

Additionally, the method may involve storing a temporary buffer of the messaging signals on the user device. This buffer allows for retrospective analysis of the messaging data, enhancing the accuracy of the content evaluation prior to transmission. The local analysis module may also integrate contextual data from external sensors or applications, such as location data or user activity logs, to refine the context evaluation and improve the decision-making process regarding the transmission of the audio signals.

Overall, the method for managing digital messaging communication provides a robust framework for ensuring secure and compliant transmission of audio signals, leveraging advanced speech recognition and content analysis techniques to maintain the integrity and quality of digital interactions.

In some embodiments, the method involves the real-time analysis of messaging data using an artificial intelligence module integrated within the communication system. This AI module is designed to process audio signals captured through a push-to-talk interface, converting them into text for further examination. The analysis process employs advanced natural language processing (NLP) techniques and machine learning algorithms to evaluate the content of the audio data.

The AI module utilizes a speech recognition model, which may be based on neural network architectures such as recurrent neural networks (RNNs) or convolutional neural networks (CNNs), to transcribe audio signals into text. This transcription process involves analyzing the acoustic features of the audio, such as tone, pitch, and volume, to ensure accurate conversion into text format.

Once the audio is transcribed, the AI module performs a detailed content analysis. This analysis includes parsing the text to identify specific keywords and applying NLP techniques to determine the sentiment of the communication. Sentiment analysis algorithms assess the emotional tone of the text, identifying whether the sentiment is positive, negative, or neutral. Additionally, the module evaluates the context using a predefined lexicon, which may include domain-specific vocabulary relevant to the communication environment.

The decision-making algorithm within the AI module utilizes the results of the content analysis to determine the appropriateness of the messaging data. This algorithm incorporates a set of predefined rules and criteria, which may include identifying harmful, offensive, policy-violating, misleading, inappropriate, or unauthorized content. The decision-making process is designed to ensure that only compliant and appropriate audio signals are transmitted to the recipient.

For example, in a customer support scenario, the AI module can detect if a user is expressing frustration or dissatisfaction, prompting the system to escalate the interaction to a human agent for resolution. Similarly, in a social communication platform, the module can identify positive sentiment, such as enthusiasm or agreement, and adjust the interaction flow accordingly to maintain engagement.

The AI module's ability to perform real-time analysis and moderation of messaging data enhances the security and quality of voice interactions. By continuously monitoring sentiment and content, the system can proactively address potential issues, such as escalating conflicts or misunderstandings, thereby fostering a positive interaction experience for all users.

In some embodiments, the method involves a process where, upon identifying a message as potentially problematic during the content analysis phase, the system flags the message for further user review. This flagging mechanism is integral to maintaining user control over the communication process, allowing the user to make an informed decision regarding the transmission of the flagged message.

The system is configured to present the flagged message to the user with a notification that clearly indicates the reason for the flagging. This notification may include specific details such as the presence of certain keywords, detected sentiment, or contextual factors that contributed to the flagging decision. For instance, if the message contains language that could be interpreted as offensive or inappropriate, the notification will highlight these elements, providing the user with a clear understanding of the potential issue.

The user interface is designed to facilitate this review process by offering intuitive options for the user to either confirm the transmission of the flagged message or cancel it entirely. This interface may include visual cues, such as color-coded alerts or icons, to draw the user's attention to the flagged message. Additionally, the interface may provide interactive elements, such as buttons or sliders, that allow the user to easily navigate the decision-making process.

For example, in a mobile application, the user might receive a pop-up notification when a message is flagged. This notification could display the flagged content alongside options such as “Send Anyway” or “Cancel Message.” By selecting “Send Anyway,” the user confirms their intention to transmit the message despite the flagged concerns. Conversely, choosing “Cancel Message” would prevent the message from being sent, allowing the user to revise or discard the content as needed.

This feature is particularly beneficial in scenarios where the context of the communication may not be fully captured by automated analysis. By involving the user in the final decision, the system ensures that messages are transmitted with the user's explicit consent, thereby enhancing the overall integrity and reliability of the communication process.

This approach not only empowers users but also aligns with privacy and compliance standards by providing a transparent and user-centric moderation mechanism.

In some embodiments, the method involves a decision-making algorithm that incorporates a machine learning model designed to adaptively refine its criteria for flagging messages based on historical user interactions and feedback. This adaptive refinement process is achieved through continuous learning and updating of the model's parameters, allowing it to respond dynamically to evolving communication patterns and user behaviors.

The machine learning model is initially trained on a comprehensive dataset that includes a wide range of communication scenarios, encompassing various linguistic styles, emotional tones, and contextual nuances. This training enables the model to establish a baseline understanding of what constitutes potentially problematic content, such as offensive language, inappropriate tone, or policy violations.

As the system is deployed and used in real-world applications, it collects data on user interactions and feedback. This data is utilized to further train and refine the model, enhancing its ability to accurately identify and flag messages that may require user review. For instance, if users frequently override the system's flagging decisions for certain types of content, the model can adjust its criteria to reduce false positives in similar contexts.

The decision-making algorithm leverages this refined model to evaluate each message in real-time, determining whether it should be flagged for further user review. The algorithm considers various factors, including the presence of specific keywords, the detected sentiment, and the contextual relevance of the message. By incorporating user feedback and historical interaction data, the algorithm can make more informed and contextually aware decisions, improving the overall accuracy and reliability of the flagging process.

For example, in a customer service application, the system may initially flag messages containing strong language as potentially inappropriate. However, if users consistently indicate that such language is acceptable in certain contexts, such as when expressing frustration over a service issue, the model can adjust its criteria to account for these nuances, reducing unnecessary flagging and enhancing user satisfaction.

In another scenario, a social media platform may use the system to moderate user comments. As users provide feedback on the system's flagging decisions, the model can learn to distinguish between playful banter and genuine harassment, refining its criteria to better align with the platform's community standards.

Overall, the adaptive refinement of the decision-making algorithm ensures that the system remains responsive to changing communication dynamics, providing a flexible and user-centric approach to content moderation. This capability enhances the system's effectiveness in maintaining a respectful and secure communication environment across diverse applications and user communities.

The method involves a process where blocked messages are not delivered, and are erased from the user device, leaving no trace on the user device. This process is implemented through a series of technical steps designed to ensure that any message deemed inappropriate or non-compliant with predefined standards is effectively removed from the system without leaving residual data.

Initially, when a message is flagged during the content analysis phase, the system evaluates the message against a set of criteria to determine its compliance with communication policies. If the message is found to contain harmful, offensive, or unauthorized content, the decision-making algorithm triggers the blocking mechanism.

Once a message is blocked, the system initiates a secure deletion process to erase the message from the user device. This process involves overwriting the message data in the device's memory, ensuring that the original content cannot be recovered. The overwriting technique may utilize multiple passes of random data to guarantee that the message is irretrievably erased, adhering to data sanitization standards.

For example, in a mobile application, when a voice message is blocked, the system immediately removes the messaging file from the device's storage. The deletion process is executed in the background, ensuring that the user experience remains uninterrupted. The system may also update the device's file allocation table to reflect the removal of the message, preventing any reference to the deleted content.

Additionally, the system is designed to ensure that no metadata or logs related to the blocked message are retained on the device. This includes removing any timestamps, sender or recipient identifiers, and message status indicators that could provide information about the blocked communication. The system's logging mechanism is configured to exclude blocked messages from audit trails, maintaining user privacy and data integrity.

In scenarios where the system operates within a networked environment, such as a corporate communication platform, the blocking and deletion process extends to any synchronized devices or cloud storage services. The system ensures that blocked messages are purged from all connected devices and servers, maintaining consistency across the communication network.

Overall, the method provides a robust framework for managing blocked messages, ensuring that they are not delivered, erased from the user device, and leave no trace. This approach enhances the security and privacy of digital communications, aligning with regulatory requirements and user expectations for data protection.

In some embodiments, the method involves a local analysis module that includes a real-time acoustic feature extraction component configured to evaluate the tone, pitch, and volume of an audio signal. This component is integrated into the user device, which is equipped with a processor and memory to execute the necessary operations. The acoustic feature extraction process begins with the capture of audio signals through the push-to-talk interface, which may be a physical button or a virtual control on a touchscreen device.

Once audio signals are captured, the real-time acoustic feature extraction component analyzes the audio data to identify key acoustic characteristics. This analysis involves the use of digital signal processing (DSP) techniques to measure the tone, pitch, and volume of the audio signals. For instance, the component may employ Fast Fourier Transform (FFT) algorithms to convert the time-domain audio signals into frequency-domain data, allowing for the precise evaluation of pitch and tone.

The tone analysis focuses on identifying the emotional quality of the speaker's voice, such as whether it is calm, excited, or aggressive. This is achieved by examining the harmonic content and spectral features of the audio signals. The pitch analysis involves determining the fundamental frequency of the speaker's voice, which can provide insights into the speaker's emotional state or intent. Volume analysis measures the amplitude of the audio signals, which can indicate the speaker's level of emphasis or urgency.

The decision-making algorithm within the local analysis module incorporates these acoustic features into the determination of whether to transmit or block the audio signals. For example, if the analysis detects a high pitch and volume, which may indicate anger or aggression, the system may flag the message for further review or block its transmission to prevent potential conflict. Conversely, if the tone is identified as neutral or positive, the system may allow the transmission to proceed.

In practical applications, this method can be used in customer service environments to ensure that communications remain professional and respectful. For instance, if a customer service representative's voice exhibits a calm tone and moderate volume, the system may prioritize the transmission of their message. However, if the analysis detects a sudden increase in volume and a shift to an aggressive tone, the system may intervene to prevent the escalation of the interaction.

Overall, the integration of real-time acoustic feature extraction into the local analysis module enhances the system's ability to evaluate the appropriateness of audio communications, ensuring that only compliant and contextually appropriate messages are transmitted. This approach contributes to a more secure and respectful communication environment across various applications and industries.

In some embodiments, the method is configured to store a temporary buffer of messaging signals on the user device, which serves as an intermediary storage area for captured audio data. This buffer allows for retrospective analysis of the audio signals, enhancing the accuracy of content evaluation prior to transmission. The temporary buffer is implemented using the device's memory resources, ensuring that the audio data is securely stored and readily accessible for analysis.

The local analysis module is designed to perform a retrospective analysis on the buffered messaging, utilizing advanced natural language processing (NLP) techniques and machine learning algorithms. This analysis involves converting the audio signals into text using a speech recognition model, which may be based on neural network architectures such as recurrent neural networks (RNNs) or convolutional neural networks (CNNs). The transcription process ensures that the audio data is accurately represented in text format, facilitating detailed examination.

Once the audio is transcribed, the local analysis module conducts a comprehensive content evaluation, which includes parsing the text to identify specific keywords, applying sentiment analysis algorithms to determine the emotional tone, and evaluating the context using a predefined lexicon. The sentiment analysis algorithms assess whether the sentiment is positive, negative, or neutral, providing insights into the speaker's emotional state or intent.

The retrospective analysis also incorporates contextual data from external sensors or applications, such as location data or user activity logs. This integration allows the system to refine the context evaluation, ensuring that the decision-making process regarding the transmission of messaging signals is informed by relevant situational factors. For example, if the user is in a specific geographic location or engaged in a particular activity, the system can adjust its analysis criteria to account for these contextual elements.

In practical applications, this method can be used in scenarios where accurate content evaluation is critical, such as in customer service environments or social communication platforms. For instance, if a customer service representative's message is flagged for potential issues, the system can utilize the temporary buffer to re-evaluate the messaging data, ensuring that the final decision to transmit is based on a thorough analysis. Similarly, in a social media application, the system can leverage contextual data to enhance the accuracy of sentiment detection, ensuring that messages are transmitted in a manner that aligns with community standards.

Overall, the integration of a temporary buffer and retrospective analysis within the local analysis module enhances the system's ability to evaluate the appropriateness of messaging communications, ensuring that only compliant and contextually appropriate messages are transmitted. This approach contributes to a more secure and respectful communication environment across various applications and industries.

In some embodiments, the system is configured to integrate contextual data from external sensors or applications, such as location data or user activity logs, to refine the context evaluation and improve the decision-making process regarding the transmission of messaging signals. This integration is achieved through a series of technical components and processes designed to enhance the accuracy and relevance of content analysis.

The user device is equipped with a suite of sensors capable of capturing various types of contextual data. These sensors may include GPS modules for determining geographic location, accelerometers for detecting movement, and gyroscopes for assessing orientation. Additionally, the device may interface with external applications that provide user activity logs, such as calendar events, task reminders, or social media interactions.

The local analysis module is designed to access and process this contextual data in real-time, utilizing it to inform the content evaluation process. For instance, the module may incorporate location data to determine whether the user is in a specific geographic area, such as a workplace or public venue, which may influence the appropriateness of certain messaging content. Similarly, user activity logs can provide insights into the user's current state or intentions, such as whether they are engaged in a meeting or leisure activity.

The decision-making algorithm within the local analysis module leverages this contextual information to refine its criteria for determining whether to transmit or block messaging signals. For example, if the user is detected to be in a professional setting, the system may apply stricter content standards to ensure that communications remain appropriate and respectful. Conversely, if the user is in a casual environment, the system may allow for more relaxed content criteria.

In practical applications, this method can be used in scenarios where context-sensitive communication is critical. For instance, in a corporate environment, the system can ensure that voice messages adhere to company policies by considering the user's location within the office premises. Similarly, in a social networking application, the system can tailor content moderation based on the user's current activity, such as attending a live event or participating in a group chat.

Overall, the integration of contextual data from external sensors or applications enhances the system's ability to evaluate the appropriateness of messaging communications, ensuring that only compliant and contextually relevant messages are transmitted. This approach contributes to a more secure and personalized communication experience across various applications and industries.

In some embodiments, the system for managing digital audio communication within a video communication context involves several technical components and processes to ensure efficient and secure analysis of audio signals. The system is designed to extract the audio portion from a video communication stream and perform a detailed content analysis to determine the appropriateness of the communication.

The process begins with the video capture module, which receives live video input from a sender's device. This module utilizes the device's camera to capture video data, which is then digitized and prepared for processing. The video capture module may employ video compression techniques, such as H.264 or VP9, to optimize the data for transmission and analysis.

Once the video data is captured, the system employs an audio extraction module to isolate the audio portion from the video stream. This module utilizes digital signal processing (DSP) techniques to separate the audio signals from the video content, ensuring that the audio data is accurately extracted for further analysis.

The extracted audio signals are then processed by an artificial intelligence (AI) moderation module, which is configured to analyze the audio data in real-time. The AI module employs machine learning algorithms, such as convolutional neural networks (CNNs) and recurrent neural networks (RNNs), to evaluate the content of the audio signals. These algorithms are trained on extensive datasets to recognize patterns indicative of inappropriate content, such as offensive language, harassment, or policy violations.

The AI moderation module also incorporates natural language processing (NLP) techniques to analyze the linguistic and contextual attributes of the audio data. This analysis involves converting the audio signals into text using automatic speech recognition (ASR) technology, followed by sentiment analysis to detect inappropriate language or tone. The sentiment analysis algorithms assess whether the sentiment is positive, negative, or neutral, providing insights into the speaker's emotional state or intent.

Upon completion of the analysis, the AI moderation module determines whether the audio portion of the video communication complies with predefined behavioral standards. If the audio is deemed appropriate, the system allows the video communication to proceed. Conversely, if the audio contains inappropriate content, the module may block the transmission of the video communication, issue warnings to the sender, or escalate the issue to human moderators for further review.

For example, in a corporate video conferencing application, the system can ensure that all participants adhere to professional communication standards by analyzing the audio content in real-time. If a participant uses inappropriate language or exhibits aggressive behavior, the system can intervene to prevent the transmission of the video communication, maintaining a respectful and secure interaction environment.

In another scenario, a social media platform may use the system to moderate live video streams. As users broadcast video content, the system continuously analyzes the audio portion to detect any violations of community guidelines. If inappropriate content is identified, the system can take immediate action to block the stream or notify the user, ensuring compliance with platform policies.

Overall, the system for managing digital audio communication within a video communication context provides a robust framework for ensuring secure and compliant transmission of audio signals, leveraging advanced speech recognition and content analysis techniques to maintain the integrity and quality of digital interactions.

In some embodiments, the system for managing digital messaging communication on a user device is designed to incorporate a content analysis component capable of analyzing images, including still images or images from a video stream, to extract text and understand the meaning of emojis. This component is integrated into the user device, which is equipped with a processor and memory to execute the necessary operations.

The process begins with the capture of images through the device's camera or from a video stream. The image capture module is responsible for digitizing the visual data, preparing it for further analysis. This module may employ image compression techniques, such as JPEG or PNG, to optimize the data for processing and storage.

Once the images are captured, the system employs an Optical Character Recognition (OCR) module to extract text from the images. The OCR module utilizes advanced algorithms to identify and convert text within the images into a machine-readable format. This process involves analyzing the visual features of the text, such as font style, size, and orientation, to ensure accurate recognition and transcription. The OCR module may employ neural network architectures, such as convolutional neural networks (CNNs), which are trained on extensive datasets to recognize various text patterns and styles.

In addition to text extraction, the content analysis component is configured to understand the meaning of emojis present in the images. This involves the use of machine learning models trained to recognize and interpret emojis based on their visual characteristics and contextual usage. The system employs a predefined lexicon of emojis, which includes their meanings and potential interpretations within different contexts. By analyzing the visual features and context of the emojis, the system can accurately determine their intended meaning and emotional tone.

The decision-making algorithm within the content analysis component utilizes the extracted text and interpreted emojis to evaluate the appropriateness of the image content. This algorithm incorporates a set of predefined rules and criteria, which may include identifying harmful, offensive, policy-violating, misleading, inappropriate, or unauthorized content. The decision-making process is designed to ensure that only compliant and appropriate images are transmitted to the recipient.

For example, in a social media application, the system can analyze user-uploaded images to ensure that they adhere to community guidelines. If the OCR module detects text containing offensive language or if the emoji analysis indicates inappropriate intent, the system may flag the image for further review or block its transmission. Similarly, in a corporate environment, the system can ensure that images shared within the organization comply with company policies by evaluating the extracted text and emojis for appropriateness.

Overall, the integration of OCR and emoji analysis within the content analysis component enhances the system's ability to evaluate the appropriateness of image content, ensuring that only compliant and contextually appropriate images are transmitted. This approach contributes to a more secure and respectful communication environment across various applications and industries.

In another aspect, the present disclosure pertains to a system for managing digital messaging communication on a user device, configured to facilitate secure and efficient transmission of various message types, including text, voice, image, and video. The system comprises several components, each contributing to the functionality and performance of the communication process.

The first component is the local analysis module, which is stored in the memory of the user device and executed by the processor. This module is responsible for processing the message content, utilizing models appropriate for the message type. For voice messages, a speech recognition model may be employed to convert audio signals into text. Such models may be based on neural network architectures, such as recurrent neural networks (RNNs) or convolutional neural networks (CNNs), trained to transcribe spoken language into text. For image and video messages, image recognition and video analysis models may be utilized to extract relevant information. This processing involves analyzing features specific to each message type to ensure accurate interpretation.

Once the message content is processed, the content analysis component takes over. This component is configured to analyze the processed content prior to its transmission to a recipient. The analysis process involves several steps, including parsing the data to identify specific keywords, applying natural language processing (NLP) techniques to determine sentiment, and evaluating the context using a predefined lexicon. For image and video content, the analysis may include object detection and scene recognition. The NLP techniques may involve sentiment analysis algorithms that assess the emotional tone of text-based content. This comprehensive analysis ensures that the content is evaluated for appropriateness and compliance with predefined communication standards.

The decision-making algorithm is the final component of the system, responsible for determining whether to transmit or block the messages in real-time based on the content analysis. This algorithm incorporates a set of predefined rules and criteria, which may include identifying harmful, offensive, policy-violating, misleading, inappropriate, or unauthorized content. The decision-making process is designed to ensure that only compliant and appropriate messages are transmitted to the recipient.

For example, in a customer service application, the system can detect if a user is expressing frustration or dissatisfaction in a text or voice message, prompting the system to escalate the interaction to a human agent for resolution. Similarly, in a social communication platform, the system can identify positive sentiment, such as enthusiasm or agreement, in any message type and adjust the interaction flow accordingly to maintain engagement.

In another scenario, the system may be used in a corporate environment to ensure that all communications adhere to company policies. The content analysis component can evaluate the message content for compliance with organizational standards, while the decision-making algorithm ensures that only appropriate messages are transmitted.

The system for managing digital messaging communication provides a framework for ensuring secure and compliant transmission of various message types, leveraging advanced recognition and content analysis techniques to maintain the integrity and quality of digital interactions.

In some embodiments, the system for managing digital messaging communication on a user device is designed to dynamically update the decision-making algorithm, ensuring that the system remains responsive to evolving communication patterns and user behaviors. This dynamic updating process involves several technical components and methodologies to enhance the system's adaptability and accuracy in content moderation.

The user device is equipped with a processor and memory, which are configured to execute the local analysis module. This module is responsible for converting audio signals into text, utilizing a speech recognition model. The speech recognition model may be based on advanced neural network architectures, such as recurrent neural networks (RNNs) or convolutional neural networks (CNNs), which are trained to accurately transcribe spoken language into text.

Once the audio signal is converted into text, the content analysis component takes over. This component is configured to analyze the generated text prior to its transmission to a recipient. The analysis process involves several steps, including parsing the text data to identify specific keywords, applying natural language processing (NLP) techniques to determine sentiment, and evaluating the context using a predefined lexicon. The NLP techniques may involve sentiment analysis algorithms that assess the emotional tone of the text, identifying whether the sentiment is positive, negative, or neutral.

The decision-making algorithm is the final component of the system, responsible for determining whether to transmit or block the messaging signals in real-time based on the content analysis. This algorithm incorporates a set of predefined rules and criteria, which may include identifying harmful, offensive, policy-violating, misleading, inappropriate, or unauthorized content. The decision-making process is designed to ensure that only compliant and appropriate messaging signals are transmitted to the recipient.

The dynamic updating of the decision-making algorithm is achieved through continuous learning and adaptation. The system collects data on user interactions and feedback, which is utilized to further train and refine the algorithm. For instance, if users frequently override the system's flagging decisions for certain types of content, the algorithm can adjust its criteria to reduce false positives in similar contexts. This adaptive refinement process allows the system to respond dynamically to changing communication dynamics, providing a flexible and user-centric approach to content moderation.

For example, in a customer service application, the system can detect if a user is expressing frustration or dissatisfaction, prompting the system to escalate the interaction to a human agent for resolution. Similarly, in a social communication platform, the system can identify positive sentiment, such as enthusiasm or agreement, and adjust the interaction flow accordingly to maintain engagement.

In another scenario, the system may be used in a corporate environment to ensure that all communications adhere to company policies. The content analysis component can evaluate the text for compliance with organizational standards, while the decision-making algorithm ensures that only appropriate messages are transmitted.

Overall, the system for managing digital messaging communication provides a robust framework for ensuring secure and compliant transmission of messaging signals, leveraging advanced speech recognition and content analysis techniques to maintain the integrity and quality of digital interactions. The dynamic updating of the decision-making algorithm enhances the system's effectiveness in maintaining a respectful and secure communication environment across diverse applications and user communities.

The system for managing digital messaging communication on a user device is designed to dynamically update the decision-making algorithm, ensuring that the system remains responsive to evolving communication patterns and user behaviors. This dynamic updating process involves several technical components and methodologies to enhance the system's adaptability and accuracy in content moderation.

Once au audio signal is converted into text, the content analysis component takes over. This component is configured to analyze the generated text prior to its transmission to a recipient. The analysis process involves several steps, including parsing the text data to identify specific keywords, applying natural language processing (NLP) techniques to determine sentiment, and evaluating the context using a predefined lexicon. The NLP techniques may involve sentiment analysis algorithms that assess the emotional tone of the text, identifying whether the sentiment is positive, negative, or neutral.

The decision-making algorithm is the final component of the system, responsible for determining whether to transmit or block the messaging signals in real-time based on the content analysis. This algorithm incorporates a set of predefined rules and criteria, which may include identifying harmful, offensive, policy-violating, misleading, inappropriate, or unauthorized content. The decision-making process is designed to ensure that only compliant and appropriate messaging signals are transmitted to the recipient.

The dynamic updating of the decision-making algorithm is achieved through continuous learning and adaptation. The system collects data on user interactions and feedback, which is utilized to further train and refine the algorithm. For instance, if users frequently override the system's flagging decisions for certain types of content, the algorithm can adjust its criteria to reduce false positives in similar contexts. This adaptive refinement process allows the system to respond dynamically to changing communication dynamics, providing a flexible and user-centric approach to content moderation.

For example, in a customer service application, the system can detect if a user is expressing frustration or dissatisfaction, prompting the system to escalate the interaction to a human agent for resolution. Similarly, in a social communication platform, the system can identify positive sentiment, such as enthusiasm or agreement, and adjust the interaction flow accordingly to maintain engagement.

In another scenario, the system may be used in a corporate environment to ensure that all communications adhere to company policies. The content analysis component can evaluate the text for compliance with organizational standards, while the decision-making algorithm ensures that only appropriate messages are transmitted.

Overall, the system for managing digital messaging communication provides a robust framework for ensuring secure and compliant transmission of messaging signals, leveraging advanced speech recognition and content analysis techniques to maintain the integrity and quality of digital interactions. The dynamic updating of the decision-making algorithm enhances the system's effectiveness in maintaining a respectful and secure communication environment across diverse applications and user communities.

The system comprises a moderation component configured to perform real-time detection of bullying, threats, or harassment within digital messaging communications. This component is integrated into the user device, which is equipped with a processor and memory to execute the necessary operations. The moderation process begins with the capture of messaging signals through the push-to-talk interface, which may be a physical button or a virtual control on a touchscreen device.

Once the messaging signals are captured, the moderation component analyzes the messaging data to identify patterns indicative of bullying, threats, or harassment. This analysis involves the use of advanced machine learning algorithms, such as convolutional neural networks (CNNs) and recurrent neural networks (RNNs), which are trained on extensive datasets containing examples of various categories of inappropriate content. These algorithms are capable of recognizing linguistic cues, acoustic features, and contextual information that may indicate harmful behavior.

The moderation component also incorporates natural language processing (NLP) techniques to enhance the analysis of linguistic and contextual attributes of audio data. This involves converting the audio signals into text using automatic speech recognition (ASR) technology, followed by sentiment analysis to detect inappropriate language or tone. The sentiment analysis algorithms assess whether the sentiment is positive, negative, or neutral, providing insights into the speaker's emotional state or intent.

Upon detection of bullying, threats, or harassment, the moderation component triggers predefined actions to address the issue. These actions may include issuing warnings to the user, blocking the transmission of the messaging signals, or escalating the interaction to human moderators for further review. The system is designed to provide real-time feedback to users regarding detected inappropriate behavior, allowing them to adjust their communication style accordingly.

In practical applications, this system can be used in environments where maintaining a respectful and secure communication atmosphere is critical, such as in educational platforms, corporate communication systems, or social media applications. For instance, in a classroom setting, the system can monitor student interactions to ensure that all communications adhere to school policies and promote a positive learning environment. Similarly, in a corporate environment, the system can help enforce company communication standards by detecting and addressing inappropriate behavior in real-time.

Overall, the integration of real-time detection of bullying, threats, or harassment within the system enhances its ability to maintain a secure and respectful communication environment, ensuring that digital interactions are compliant with predefined behavioral standards.

The system for managing digital messaging communication on a user device is designed to incorporate user-device-level policy enforcement to ensure regulatory compliance. This system is equipped with a processor and memory, which are configured to execute a local analysis module. The local analysis module is responsible for converting audio signals into text, utilizing a speech recognition model. This model may be based on advanced neural network architectures, such as recurrent neural networks (RNNs) or convolutional neural networks (CNNs), which are trained to accurately transcribe spoken language into text. The conversion process involves analyzing the acoustic features of the audio signals, such as tone, pitch, and volume, to ensure precise transcription.

Once the audio signal is converted into text, the content analysis component takes over. This component is configured to analyze the generated text prior to its transmission to a recipient. The analysis process involves several steps, including parsing the text data to identify specific keywords, applying natural language processing (NLP) techniques to determine sentiment, and evaluating the context using a predefined lexicon. The NLP techniques may involve sentiment analysis algorithms that assess the emotional tone of the text, identifying whether the sentiment is positive, negative, or neutral. This comprehensive analysis ensures that the content is evaluated for appropriateness and compliance with predefined communication standards.

The decision-making algorithm is the final component of the system, responsible for determining whether to transmit or block the messaging signals in real-time based on the content analysis. This algorithm incorporates a set of predefined rules and criteria, which may include identifying harmful, offensive, policy-violating, misleading, inappropriate, or unauthorized content. The decision-making process is designed to ensure that only compliant and appropriate messaging signals are transmitted to the recipient. The system's ability to enforce user-device-level policies ensures that all communications adhere to regulatory requirements, providing a secure and compliant communication environment across diverse applications and user communities.

In some embodiments, the system for managing digital messaging communication on a user device incorporates a speech recognition model that is based on neural network architectures. This model is integral to the local analysis module, which is stored in the memory of the user device and executed by the processor. The primary function of this module is to convert audio signals into text.

The neural network-based speech recognition model is designed to accurately transcribe spoken language into text by analyzing the acoustic features of the audio signals. These features include tone, pitch, and volume, which are critical for ensuring precise transcription. The model may utilize advanced neural network architectures, such as recurrent neural networks (RNNs) or convolutional neural networks (CNNs), which are trained on extensive datasets to recognize and process various speech patterns and linguistic nuances.

Once the audio signal is converted into text, the content analysis component of the system takes over. This component is configured to analyze the generated text prior to its transmission to a recipient. The analysis process involves several steps, including parsing the text data to identify specific keywords, applying natural language processing (NLP) techniques to determine sentiment, and evaluating the context using a predefined lexicon. The NLP techniques may involve sentiment analysis algorithms that assess the emotional tone of the text, identifying whether the sentiment is positive, negative, or neutral.

The decision-making algorithm is the final component of the system, responsible for determining whether to transmit or block the messaging signals in real-time based on the content analysis. This algorithm incorporates a set of predefined rules and criteria, which may include identifying harmful, offensive, policy-violating, misleading, inappropriate, or unauthorized content. The decision-making process is designed to ensure that only compliant and appropriate messaging signals are transmitted to the recipient.

Overall, the system for managing digital messaging communication provides a robust framework for ensuring secure and compliant transmission of messaging signals, leveraging advanced speech recognition and content analysis techniques to maintain the integrity and quality of digital interactions. The use of a neural network-based speech recognition model enhances the system's ability to accurately transcribe and analyze audio content, contributing to a more secure and respectful communication environment across diverse applications and user communities.

The system for managing digital messaging communication on a user device is designed to incorporate a content analysis component that is configured to identify harmful, offensive, policy-violating, misleading, inappropriate, or unauthorized content. This component is integrated into the user device, which is equipped with a processor and memory to execute the necessary operations. The content analysis process begins with the capture of messaging signals through the push-to-talk interface, which may be a physical button or a virtual control on a touchscreen device.

Once the messaging signals are captured, the system employs a local analysis module to convert the messaging signals into text. This conversion is facilitated by a speech recognition model, which may be based on advanced neural network architectures, such as recurrent neural networks (RNNs) or convolutional neural networks (CNNs). These models are trained on extensive datasets to accurately transcribe spoken language into text, ensuring that the audio content is represented in a format suitable for detailed analysis.

The content analysis component is responsible for evaluating the generated text to identify specific categories of content that may be deemed harmful, offensive, policy-violating, misleading, inappropriate, or unauthorized. This evaluation involves several technical steps, including parsing the text data to identify specific keywords or phrases that are indicative of such content. The component utilizes natural language processing (NLP) techniques to enhance the analysis, applying sentiment analysis algorithms to assess the emotional tone of the text and determine whether the sentiment is positive, negative, or neutral.

In addition to sentiment analysis, the content analysis component incorporates contextual evaluation using a predefined lexicon. This lexicon includes domain-specific vocabulary relevant to the communication environment, allowing the system to accurately assess the appropriateness of the content within its specific context. The component may also integrate contextual data from external sensors or applications, such as location data or user activity logs, to refine the analysis and ensure that the decision-making process regarding the transmission of messaging signals is informed by relevant situational factors.

Upon completion of the content analysis, the system utilizes a decision-making algorithm to determine whether to transmit or block the messaging signals in real-time. This algorithm incorporates a set of predefined rules and criteria, which are designed to ensure that only compliant and appropriate messaging signals are transmitted to the recipient. If the content is identified as harmful, offensive, policy-violating, misleading, inappropriate, or unauthorized, the system may block the transmission, issue warnings to the user, or escalate the interaction to human moderators for further review.

Overall, the integration of a content analysis component within the system enhances its ability to maintain a secure and respectful communication environment, ensuring that digital interactions are compliant with predefined behavioral standards. This approach contributes to a more secure and personalized communication experience across various applications and industries.

In some embodiments, the system for managing digital messaging communication on a user device is designed to incorporate a decision-making algorithm that includes a machine learning model trained to adaptively refine its criteria for flagging messages based on historical user interactions and feedback. This system is equipped with a processor and memory, which are configured to execute the local analysis module. The local analysis module is responsible for converting audio signals into text, utilizing a speech recognition model. The speech recognition model may be based on advanced neural network architectures, such as recurrent neural networks (RNNs) or convolutional neural networks (CNNs), which are trained to accurately transcribe spoken language into text.

Once an audio signal is converted into text, the content analysis component takes over. This component is configured to analyze the generated text prior to its transmission to a recipient. The analysis process involves several steps, including parsing the text data to identify specific keywords, applying natural language processing (NLP) techniques to determine sentiment, and evaluating the context using a predefined lexicon. The NLP techniques may involve sentiment analysis algorithms that assess the emotional tone of the text, identifying whether the sentiment is positive, negative, or neutral.

The decision-making algorithm is the final component of the system, responsible for determining whether to transmit or block the messaging signals in real-time based on the content analysis. This algorithm incorporates a set of predefined rules and criteria, which may include identifying harmful, offensive, policy-violating, misleading, inappropriate, or unauthorized content. The decision-making process is designed to ensure that only compliant and appropriate messaging signals are transmitted to the recipient.

The machine learning model within the decision-making algorithm is trained on a comprehensive dataset that includes a wide range of communication scenarios, encompassing various linguistic styles, emotional tones, and contextual nuances. This training enables the model to establish a baseline understanding of what constitutes potentially problematic content, such as offensive language, inappropriate tone, or policy violations.

As the system is deployed and used in real-world applications, it collects data on user interactions and feedback. This data is utilized to further train and refine the model, enhancing its ability to accurately identify and flag messages that may require user review. For instance, if users frequently override the system's flagging decisions for certain types of content, the model can adjust its criteria to reduce false positives in similar contexts.

In practical applications, this system can be used in environments where maintaining a respectful and secure communication atmosphere is critical, such as in educational platforms, corporate communication systems, or social media applications. For instance, in a classroom setting, the system can monitor student interactions to ensure that all communications adhere to school policies and promote a positive learning environment. Similarly, in a corporate environment, the system can help enforce company communication standards by detecting and addressing inappropriate behavior in real-time.

Overall, the integration of a machine learning model within the decision-making algorithm enhances the system's ability to maintain a secure and respectful communication environment, ensuring that digital interactions are compliant with predefined behavioral standards. This approach contributes to a more secure and personalized communication experience across various applications and industries.

In some embodiments, the system for managing digital messaging communication on a user device is designed to incorporate a content analysis component that includes a real-time acoustic feature extraction component. This component is configured to evaluate the tone, pitch, and volume of an audio signal. The system is equipped with a processor and memory, which are configured to execute the local analysis module. This module is responsible for converting audio signals captured through a push-to-talk interface into text, utilizing a speech recognition model. The speech recognition model may be based on advanced neural network architectures, such as recurrent neural networks (RNNs) or convolutional neural networks (CNNs), which are trained to accurately transcribe spoken language into text.

Once the audio signal is converted into text, the content analysis component takes over. This component is configured to analyze the generated text prior to its transmission to a recipient. The analysis process involves several steps, including parsing the text data to identify specific keywords, applying natural language processing (NLP) techniques to determine sentiment, and evaluating the context using a predefined lexicon. The NLP techniques may involve sentiment analysis algorithms that assess the emotional tone of the text, identifying whether the sentiment is positive, negative, or neutral.

The decision-making algorithm is the final component of the system, responsible for determining whether to transmit or block the messaging signals in real-time based on the content analysis. This algorithm incorporates a set of predefined rules and criteria, which may include identifying harmful, offensive, policy-violating, misleading, inappropriate, or unauthorized content. The decision-making process is designed to ensure that only compliant and appropriate messaging signals are transmitted to the recipient.

The real-time acoustic feature extraction component plays a crucial role in the decision-making process by providing additional data points for evaluating audio signals. By analyzing the tone, pitch, and volume of the audio, the system can gain insights into the speaker's emotional state or intent, which can be critical for determining the appropriateness of the communication. For example, a high pitch and volume may indicate anger or aggression, prompting the system to flag the message for further review or block its transmission to prevent potential conflict. Conversely, a calm tone and moderate volume may suggest a neutral or positive sentiment, allowing the transmission to proceed.

Overall, the integration of real-time acoustic feature extraction into the content analysis component enhances the system's ability to evaluate the appropriateness of audio communications, ensuring that only compliant and contextually appropriate messages are transmitted. This approach contributes to a more secure and respectful communication environment across various applications and industries.

In some embodiments, the system for managing digital messaging communication on a user device is designed to facilitate secure and efficient transmission of audio signals, particularly when integrated within a video communication context. The system comprises several key components, each playing a crucial role in the overall functionality and performance of the communication process.

The first component is the local analysis module, which is stored in the memory of the user device and executed by the processor. This module is responsible for converting the audio signal into text, utilizing a speech recognition model. The speech recognition model may be based on advanced neural network architectures, such as recurrent neural networks (RNNs) or convolutional neural networks (CNNs), which are trained to accurately transcribe spoken language into text. This conversion process involves analyzing the acoustic features of the audio signals, such as tone, pitch, and volume, to ensure precise transcription.

Once the audio signal is converted into text, the content analysis component takes over. This component is configured to analyze the generated text prior to its transmission to a recipient. The analysis process involves several steps, including parsing the text data to identify specific keywords, applying natural language processing (NLP) techniques to determine sentiment, and evaluating the context using a predefined lexicon. The NLP techniques may involve sentiment analysis algorithms that assess the emotional tone of the text, identifying whether the sentiment is positive, negative, or neutral. This comprehensive analysis ensures that the content is evaluated for appropriateness and compliance with predefined communication standards.

The decision-making algorithm is the final component of the system, responsible for determining whether to transmit or block the audio signals in real-time based on the content analysis. This algorithm incorporates a set of predefined rules and criteria, which may include identifying harmful, offensive, policy-violating, misleading, inappropriate, or unauthorized content. The decision-making process is designed to ensure that only compliant and appropriate audio signals are transmitted to the recipient.

In the context of video communication, the system is configured to analyze the audio portion of the communication stream and determine whether to transmit or block the video communication in real-time. This involves evaluating the audio content for compliance with predefined behavioral standards and making a decision based on the analysis results. If the audio is deemed appropriate, the system allows the video communication to proceed.

Conversely, if the audio contains inappropriate content, the module may block the transmission of the video communication, issue warnings to the sender, or escalate the issue to human moderators for further review.

For example, in a corporate video conferencing application, the system can ensure that all participants adhere to professional communication standards by analyzing the audio content in real-time. If a participant uses inappropriate language or exhibits aggressive behavior, the system can intervene to prevent the transmission of the video communication, maintaining a respectful and secure interaction environment.

Overall, the system for managing digital messaging communication within a video communication context provides a robust framework for ensuring secure and compliant transmission of text, audio (voice), image and video signals, leveraging advanced speech recognition and content analysis techniques to maintain the integrity and quality of digital interactions.

In some embodiments, the decision-making algorithm is updated dynamically. The system is designed to ensure that the content moderation process remains responsive to evolving communication patterns and user behaviors. The dynamic updating process involves continuous learning and adaptation, allowing the system to refine its criteria for content evaluation based on real-time data and user feedback.

The system comprises a local analysis module stored in the memory of the user device and executed by the processor. This module processes communication signals, converting non-text signals into text using a recognition model appropriate to the signal type. The content analysis component then evaluates the text or generated text prior to transmission, employing natural language processing techniques to determine sentiment and context.

The decision-making algorithm, which is dynamically updated, incorporates a machine learning model trained on a comprehensive dataset. This model adapts its criteria for flagging messages based on historical user interactions and feedback, ensuring that the system remains accurate and relevant in its content moderation efforts.

For example, in a social media application, the system can dynamically adjust its moderation criteria to account for new slang or emerging communication trends. As users interact with the platform and provide feedback on flagged content, the system learns to distinguish between acceptable and inappropriate language, refining its decision-making process to better align with community standards. This adaptability enhances the system's effectiveness in maintaining a respectful and secure communication environment.

In some embodiments, the system for managing digital messaging communication on a user device is designed to incorporate a feature that allows a user to “undo” or cancel a sent message while the system is in the process of checking it and before it is actually transmitted to the recipient. This feature is implemented through a series of technical components and processes that ensure user control over the communication process.

The user device is equipped with a processor and memory, which are configured to execute a local analysis module. This module is responsible for processing the messaging signals, which may include text, audio, images, or video. The local analysis module performs a preliminary analysis of the messaging data to identify any potential issues, such as harmful or unauthorized content, before the message is transmitted.

During this analysis phase, the system provides the user with an option to “undo” or cancel the message. This is facilitated through a user interface that includes an interactive control, such as a button or gesture, allowing the user to retract the message. The interface may display a notification or prompt indicating that the message is being analyzed and that the user has a limited time to cancel the transmission.

For example, in a mobile application, the user might see a progress bar or countdown timer indicating the duration of the analysis phase. During this period, the user can tap a “Cancel” button to retract the message. If the user chooses to cancel, the system halts the analysis process and prevents the message from being sent. The message is then removed from the transmission queue, and any associated data is erased from the device's memory, ensuring that no trace of the message remains.

The system may also incorporate a temporary buffer to hold the messaging data during the analysis phase. This buffer allows the system to pause the transmission process, providing the user with an opportunity to review and cancel the message if necessary. The buffer is implemented using the device's memory resources, ensuring that the data is securely stored and readily accessible for user intervention.

In practical applications, this “undo” feature can be particularly beneficial in scenarios where users may need to retract messages due to errors, changes in context, or reconsideration of the content. For instance, in a corporate communication platform, a user may realize that a message contains sensitive information and decide to cancel it before it is sent. Similarly, in a social media application, a user may wish to retract a message that was composed in haste or under emotional duress.

Overall, the integration of an “undo” or cancel feature within the system enhances user control over digital messaging communication, ensuring that messages are transmitted only with the user's explicit consent. This approach contributes to a more secure and user-friendly communication environment across various applications and industries.

1. A method for managing digital messages, comprising:
(i) providing a user device equipped with a processor and a memory, wherein the user device is configured to transmit messages using communication signals through an interface, wherein the communication signals comprise any combination of text, audio, images, and video;
(ii) executing a local analysis module stored in the memory and executed by the processor to process communication signals, wherein if the signal is not text, the module converts the signal to text utilizing a recognition model appropriate to the signal type;
(iii) analyzing the text or converted text prior to transmission to a recipient, wherein the analysis comprises one or more of parsing the text data to identify keywords, applying natural language processing techniques to determine sentiment, and evaluating context using a predefined lexicon; and
(iv) based on the content analysis, determining whether to transmit or block the communication signals in real-time by utilizing a decision-making algorithm.

2. The method of claim 1, wherein voice communication signals are converted to text using a neural network-based speech recognition model.

3. The method of claim 1, wherein the communication signal is a video communication, and based on the content analysis of the digital audio communication, determining whether to transmit or block the video communication in real-time by utilizing a decision-making algorithm.

4. The method of claim 1, wherein the local analysis comprises identifying harmful, offensive, policy-violating, misleading, inappropriate, or unauthorized content.

5. The method of claim 1, wherein step (iv) also includes flagging the message and allowing the user to decide whether to send or cancel the flagged message.

6. The method of claim 5, wherein the decision-making algorithm further comprises a machine learning model trained to adaptively refine its criteria for flagging messages based on historical user interactions and feedback.

7. The method of claim 5, wherein the flagged message is presented to the user with a notification indicating the reason for flagging, and the user interface provides options for the user to either confirm the transmission, or cancel the message entirely.

8. The method of claim 1, wherein blocked messages are not delivered, erased from the user device and leave no trace on the user device.

9. The method of claim 1, wherein the local analysis module further comprises a real-time acoustic feature extraction component configured to evaluate the tone, pitch, and volume of au audio communication signal, and wherein the decision-making algorithm incorporates these acoustic features into the determination of whether to transmit or block the audio signals.

10. The method of claim 1, wherein the user device is further configured to store a temporary buffer of the communication signals, and the local analysis module is configured to perform a retrospective analysis on the buffered audio to enhance the accuracy of the content evaluation prior to transmission.

11. The method of claim 1, wherein the local analysis module is configured to integrate contextual data from external sensors or applications, such as location data or user activity logs, to refine the context evaluation and improve the decision-making process regarding the transmission of the audio signals.

12. A system for managing digital messages on a user device equipped with a processor and a memory, and configured to transmit message using communication signals, wherein the communication signals comprise any combination of text, audio, images, and video, the system comprising:
(i) a local analysis module stored in the memory and executed by the processor, to process communication signals, wherein if the signal is not text, the module converts the signal to text utilizing a recognition model appropriate to the signal type;
(ii) a content analysis component configured to analyze the text or generated text prior to transmission to a recipient, wherein the analysis comprises one or more of parsing the text data to identify keywords, applying natural language processing techniques to determine sentiment, and evaluating context using a predefined lexicon; and
(iii) a decision-making algorithm configured to determine whether to transmit or block the communication signals in real-time based on the content analysis.

13. The system of claim 12, wherein the decision-making algorithm is updated dynamically.

14. The system of claim 12, wherein the moderation includes real-time detection of bullying, threats, or harassment.

15. The system of claim 12, further comprising user-device-level policy enforcement for regulatory compliance.

16. The system of claim 12, wherein voice communication signals are converted to text using a neural network-based speech recognition model.

17. The system of claim 12, wherein the content analysis component is configured to identify harmful, offensive, policy-violating, misleading, inappropriate, or unauthorized content.

18. The system of claim 12, wherein the decision-making algorithm further comprises a machine learning model trained to adaptively refine its criteria for flagging messages based on historical user interactions and feedback.

19. The system of claim 12, wherein the content analysis component includes a real-time acoustic feature extraction component configured to evaluate the tone, pitch, and volume of the audio signal, and wherein the decision-making algorithm incorporates these acoustic features into the determination of whether to transmit or block the audio signals.

20. The system of claim 12, wherein the digital audio communication is part of a video communication, and based on the content analysis of the digital audio communication, determining whether to transmit or block the video communication in real-time by utilizing a decision-making algorithm.
